(19) United States
(12) Patent Application Publication
(10) Pub. No.: US 2014/0023774 A1
(43) Pub. Date: Jan. 23, 2014

(54) METHODS OF PREPARING POTATO FOOD PRODUCTS WITH ENHANCED RESISTANT STARCH CONTENT

(71) Applicant: Kerry C. Huber, Moscow, ID (US)

(72) Inventor: Kerry C. Huber, Moscow, ID (US)

(73) Assignee: UNIVERSITY OF IDAHO, Moscow, ID (US)

(21) Appl. No.: 13/983,363

(22) PCT Filed: Feb. 6, 2012
(86) PCT No.: PCT/US12/23968

§ 371 Date: Oct. 10, 2013

Related U.S. Application Data
(60) Provisional application No. 61/439,637, filed on Feb. 4, 2011.

(51) Int. Cl. A23L 1/216

(52) U.S. Cl. CPC A23L 1/216
USPC 426/637; 426/523

(57) ABSTRACT

This application relates to compositions comprising whole-tissue potato products with enhanced resistant starch (RS) content and reduced estimated glycemic index values. Methods of preparing and using whole-tissue potato products with enhanced resistant starch (RS) content and glycemic index values are also disclosed.

### RELATED APPLICATIONS

This application claims the benefit of priority to U.S. Provisional Application No. 61/439,637, filed Feb. 4, 2011, incorporated herein by reference in its entirety.

### FIELD OF THE DISCLOSURE

The present invention relates compositions comprising potato products with enhanced resistant starch (RS) and/or slowly-digestible starch (SDS) content, method of using same, and methods of making same.

### BACKGROUND OF THE DISCLOSURE

Though potato starch in its native granular form within the raw tissue is extremely resistant to human digestion, the potato is rarely processed or consumed without first being subjected to heating or cooking. Upon cooking, starch granules undergo swelling and gelatinization (loss of granular and molecular order), rendering the starch molecules readily digestible. In fact, the human glycemic response for cooked (gelatinized) potato starch does not differ much from that of refined sugar, placing it in a high glycemic category as a food to avoid for those with need to control blood sugar.

One strategy for decreasing the glycemic response of food products is related to increasing their levels of resistant starch(RS), which is defined as starch material that escapes digestion by human enzymes present within the small intestine (Englyst et al., 1992). Consequently, RS passes into the large intestine undigested, where it is fermented by bacterial microflora within the colon into short-chain fatty acids and other secondary products. Resistant starch offers important physiological benefits including moderation of blood sugar levels and production of butyrate (biomarker for colonic health) in decreasing risk for development of chronic human disease (Kendall et al., 2004). Development of multifunctional potato products and/or ingredients with increased RS levels and a moderated glycemic response may be one way to continue to effectively promote utilization of potatoes.

Of the five primary categories of potato products in the U.S. market (fresh, canned, frozen, chipped, and dehydrated), dehydrated potato products represent an underutilized commodity at present, but have great market potential for growth due to their availability, convenience, low cost, versatility, and stability as a potential food ingredient. The main dehydrated potato products are potato flakes and granules. However, during the processing of these products, potatoes are cooked, which generally translates them into a high glycemic food category.

While there are over 2000 species of potatoes, approximately eight of them are commonly cultivated. Solanum tuberosum, including two subspecies andigena and tuberosum, is the most common cultivated species.

Starch Granules. Starch granules consist of crystalline aggregates of amylose and amylopectin polymers, and are synthesized and organized in parenchyma cells within the amyloplast. Potato starch granules range in size from 5 to 110 μm (Leszczyński, 1989), and possess an amylose:amylopectin ratio of approximately 1:3 (Talburt et al., 1975). Amylose is a predominantly linear polymer of (1→4)-linked α-D-glucopyranosyl units, which can possess a few short α-(1→6) branches (BeMiller and Whistler, 1996). Amylopectin is also comprised of both α-(1→4) and α-(1→6) glycosidic linkages, but is a comparatively larger molecule possessing a branch-on-branch structure. In addition, potato amylopectin possesses some phosphate ester groups, which are covalently linked at the 0-3 and O-6 positions of some amylopectin anhydroglucose units. Potato starch contains only small amounts of lipid (0.06% w/w) and protein (0.05% w/w), compared to cereal starches (0.6-1% and 0.25-0.6% w/w for lipid and protein, respectively) (Debet and Gidley, 2006). Swelling and gelatinization of starch granules during heating or cooking has been reported to influence cell parenchyma separation in cooked potatoes, and will be discussed in more detail in a later section.

Heat Treatment. Generally, the native cellular structure in fresh potato tissue is preserved by strong intercellular adhesion by pectic substances within the middle lamella and by the maintenance of turgor pressure within parenchyma cells. Heating is one of the most effective methods for disrupting intercellular adhesion and inducing loss of turgor, and is the process whereby instant mashed potato granules are processed commercially. In potato tuber tissue, loss of tissue integrity has been observed to occur at temperatures as low as 50° C. (Andersson et al., 1994). Greve et al. (1994) reported that the turgor pressure of carrot cells was readily lost by boiling in water. Other factors that affect the separation of potato tissue cells during heating are the solubilization of pectic substances in the middle lamella and the swelling power of starch granules within the cells. Nevertheless, the disintegration of potato tissue into individual cells during heating is due primarily to degradation of pectic substances within the middle lamella and secondarily to the swelling of starch granules within cells (Andersson et al., 1994; Matsuura-Endo et al., 2002; Ormerod et al., 2002). Starch swelling may aid cell separation by exerting internal pressure within parenchyma cells that leads to ‘rounding off’ and increased size of cells (Jarvis et al., 1992; Andersson et al., 1994; Jarvis, 1998). Conversely, preheating potato tissue at low temperatures (50 to 80° C.) for long periods of time (2 min to 24 hr) or at high temperatures (80 to 100° C.). for short periods of time (10 sec to 2 min) has resulted in a firming effect on the cooked potato tissue texture (Andersson et al., 1994).

Though high temperature/long time heat treatment has been shown as an effective method for inducing cell separation in potato tissue, potato starch will have undergone gelatinization under such conditions. The gelatinization of potato may begin within the range of 53.9 to 63.5° C. (Andersson et al., 1994). Following gelatinization, starch becomes readily digestible by human enzymes, eliciting a high glycemic response. Thus, heat treatment alone will not likely prove capable of separating potato cells without gelatinizing the starch. Nevertheless, heat treatment below the starch gelatinization temperature might be combined with other methods to help promote potato parenchyma cell separation.

Acid Treatment. Acid treatment is another method that has been shown to degrade pectic substances. Glycosidic bond hydrolysis, de-esterification, and β-elimination reactions are the primary modes of pectin degradation that can occur during acid treatment. Generally, acid hydrolysis of glycosidic linkages is the main mechanism for disintegration of pectic substances within the cell wall middle lamella at pH values below 3.8, though an increased temperature can further enhance the effect of acid treatment (Kral) and McFeeters, 1998). However, Krall and McFeeters (1998) reported that β-elimination became the dominant mode of pectin depolymerization at pH values above 3.8. Other evidence supporting the use of acid treatment for degradation of pectic substances has been presented in numerous other studies involving cell wall and pectin characteristics (Norman and Martin, 1930; Sakamoto et al., 1994; Eriksson et al., 1997; Krall and McFeeters, 1998; Turquois et al., 1999; Pagán and Ibarz, 1999; Thomas and Thibault, 2002; Mesbahi et al., 2005). For example, Sakamoto et al. (1994) reported that 20% pectin could be extracted from potato protopectin subjected to treatment with HCl (pH 1.5) at 80° C. for 5 h. Turquois et al. (1999) extracted 80% of the pectin from potato pulp by heating it to 75° C. for 1 h in the presence of 5N HCl (pH 3.5) and 0.75% (w/w) sodium hexametaphosphate (SHMP).

These results indicate that acid in conjunction with heat treatment has good potential to extract pectin from potato tissue.

Alkaline Treatment. Alkaline treatment has also been shown to disintegrate and solubilize pectic substances. In this type of treatment, the β-elimination reaction is one of the most important degradation mechanisms for pectin, while alkaline treatment also releases pectic substances bound within the tissue by covalent, alkali-labile cross-links (Eriksson et al. 1997). Multiple studies have used alkaline treatment to degrade pectic substances within plant tissues (Norman and Martin, 1930; Ryden et al., 1990; Chavez et al., 1996; Eriksson et al., 1997; Turquois et al., 1999; Mondal et al., 2002; Thomas and Thibault, 2002). In a study with potatoes, Ryden et al. (1990) solubilized cell wall polysaccharides of potato tissue using a sequential extraction scheme, in which cyclohexane-trans-1,2 diaminetetraacetate (CDTA), Na₂CO₃, KOH, and KOH+borate were used in succession. Their findings showed that the CDTA-extractable pectins were less branched than those solubilized by Na₂CO₃ and that the less branched xyloglucans required solubilization in strong alkaline (KOH) solution. Chavez et al. (1996) used sodium hydroxide to study chemical peeling of potatoes, and observed that starch hydrolysis, middle lamella dissolution, and cell wall disruption all occurred within potato tissue under alkaline condition. Turquois et al. (1999) extracted pectin from sugar beet pulp and potato pulp over a 2 hr period using 0.05 M sodium hydroxide containing 0.75% (w/w) SHMP at 25° C. This alkaline treatment reduced the degree of esterification and the degree of acetylation of pectin extracts. However, alkaline treatment was not as productive of a method for pectin extraction compared to acid treatment. Though the extractability of pectic substances by alkaline treatment was lower than that of the acid extraction method, the alkaline treatment still has good potential to separate potato parenchyma cells without gelatinizing and/or hydrolyzing the starch within the tissue and to produce soluble pectins as byproducts cell separation.

Chelating Agents. Chelating or sequestering agents have been commonly used to solubilize pectins and induce cell separation in various research studies. Ethylenediaminetetraacetic acid (EDTA), cyclohexane-trans-1,2-diaminetetraacetate (CDTA), and sodium hexametaphosphate (SHMP) are examples of chelating agents that have been used to solubilize pectic substances in previous research studies. The main purpose for these chelating agents is to release pectic substances that are bound by Ca2+ ion bridges. In most previous studies, chelating agents were generally used in conjunction with aqueous (Strasser and Amado, 2002), acid (Turquois et al., 1999), alkali (Ryden et al., 1990; Eriksson et al., 1997; Turquois et al., 1999), and enzyme (Renard, 2005) treatments. Thus, the use of chelating agents to solubilize pectin and facilitate parenchyma cell separation is deemed to be most appropriate as a supporting element, rather than a standalone treatment.

Enzyme Treatment. Generally, the enzymes that hydrolyze pectic substances are called pectinolytic enzymes or pectinases. Pectinolytic enzymes can be found in many plants and microorganisms, in which they fulfill many important biological roles and tasks critical to the needs of the organism. For example, they provide cell wall extension and softening of plant tissue during growth and storage, and they also maintain ecological balance by decomposing and recycling the waste of plant materials (Jayani et al., 2005). Even though pectinolytic enzymes can be found in many plants, microbial pectinolytic enzymes are the most useful to commercial processing operations. Jayani et al. (2005) categorized microbial pectinolytic enzymes into two main groups, esterases and depolymerases. Esterases catalyze the deesterification of pectin by removing methyl esters, while depolymerases catalyze the hydrolysis (hydrolases) or trans-elimination (lyases) of glycosidic bonds.

Esterases. Pectinesterase (PE), also called pectin methyl esterase, pectase, pectin methoxylase, pectin demethoxylase and/or pectolipase, is the enzyme that catalyzes the deesterification of methyl ester linkages of pectinic acids to yield pectic acid and methanol. Microbial PE acts in random mode, while plant PE acts either at the non-reducing end or adjacent to a free carboxyl group (Jayani et al., 2005). PE activities have been found to be useful in the fruit and vegetable processing industry, including that of potato. Activation of plant PE was found to catalyze a firming effect in plant tissues (McMillan and Pérombelon, 1995; González-Martinez et al., 2004; Ni et al., 2005; Abu-Ghannam and Crowley, 2006; Anthon and Barrett, 2006; Kaaber et al., 2007). It has been hypothesized that the activation of PE might increase the number of carboxylate groups available for intermolecular cross-bridging via Ca2+ ions. Though activation of PE may prevent cell separation due to the proposed firming effect, activation of PE might still aid cell separation when polygalacturonases are used, since pectic acids produced in the PE reaction provide additional substrate for reaction with PG.

Depolymerases. Hydrolases. Protopectinases (PPase) catalyze the solubilization of protopectin via random cleavage of glycosidic bonds to yield soluble pectin. This reaction occurs at two different sites on pectic substances, the inner site (A-type), within the polygalacturonic acid region, and the outer site (B-type), at the point of connection between polygalacturonic acid chains and other cell wall constituents (Jayani et al., 2005).

Polygalacturonases (PG) catalyze the hydrolysis of glycosidic bonds of polygalacturonic acids. Both endo-polygalacturonases and exo-polygalacturonases are available from microbial sources, and produce oligogalacturonates and monogalacturonates, respectively. PG requires a carboxylic acid group at C-6 of the galacturonic acid to activate the enzyme, while PMG requires a methyl group at C-6 to activate the enzyme. Moreover, there are other hydrolase enzymes that work similarly to PG, such as exopolygalacturonan-digalacturono hydrolase, oligogalacturonate hydrolase, and 4:5 unsaturated oligogalacturonate hydrolase. These enzymes require various types of substrates and differ in their patterns of action.

Lyases. Lyases attack the glycosidic bonds of polygalacturonic acids by trans-elimination; they break the glycosidic bond at C-4 and eliminate H from C-5. As a result, a Δ 4:5 unsaturated product will be produced(Jayani et al., 2005). Lyases can be categorized into five specific groups based on their primary substrates and patterns of action. These enzymes include endopolygalacturonate lyases, exopolygalacturonate lyases, oligo-D-galactosiduronate lyases, endopolymethylgalacturonate lyases and exopolymethylgalacturonate lyases.

There is a need for potato products with moderated glycemic response. Such products would allow U.S. potato growers and processors to expand and diversify into market areas that are presently inaccessible. Of the various types of potato products on the market, dehydrated granules or flakes represent perhaps the most satisfactory vehicle for creating a product that is not only nutritionally and organoleptically adequate, but remains so over an extended storage period (Hadziyev and Steele, 1979). Dehydrated mashed potato products themselves are an important segment of potato-based convenience foods for both individual households and for catering institutions, and also represent an ideal and versatile product form for use as a food ingredient.

As potatoes represent an important source of carbohydrate in the human diet, there is potential benefit in producing potato-based products with an enhanced RS content and a moderated glycemic response. Such an approach could help counter the negative consumer perception associated with potatoes, and encourage consumers to continue to take advantage of the many positive nutritional benefits afforded by potato products (e.g. vitamin C content, high quality protein, etc.). With the ability to produce potato-based products with moderated glycemic response, the potato industry will be better positioned to respond to increasing consumer demands for healthier foods, both from a food ingredient and/or a consumer end-product standpoint. This type of product diversification will allow U.S. potato processors to remain competitive in domestic and global markets

The foregoing description of related art is not intended in any way as an admission that any of the documents described therein, including pending United States patent applications, are prior art to embodiments of the present disclosure. Moreover, the description herein of any disadvantages associated with the described products, methods, and/or apparatus, is not intended to limit the disclosed embodiments. Indeed, embodiments of the present disclosure may include certain features of the described products, methods, and/or apparatus without suffering from their described disadvantages.

### SUMMARY OF THE DISCLOSURE

The present invention provides for the application of whole-tissue potato ingredients (possessing starch in the ungelatinized state) as a source of resistant starch in low-moisture food systems.

According to some embodiments, a method is provided for preparing a food product ready for consumption (e.g., cooked/heated) comprising about 5% to about 95% w/w resistant starch. In some embodiments, methods are provided comprising heating an uncooked food product at a temperature of between about 60° C. and 250° C., said uncooked food product comprising starch granules, wherein greater than about 5% to about 95% w/w of the starch granules are in the native, ungelatinized, and/or semi-crystalline state, and wherein the moisture content of the uncooked food product is between about 2% and about 35% w/w. In some embodiments, the starch is modified according to the methods described herein.

In some embodiments, methods are provided comprising heating an uncooked food product at a temperature of between about 60° C. and 250° C., said uncooked food product comprising greater than about 5% to about 95% w/w type 2 resistant starch (RS2), and wherein the moisture content of the uncooked food product is between about 2% and about 35% w/w. In some embodiments, the starch is modified according to the methods described herein.

In some embodiments, methods are provided comprising heating an uncooked food product at a temperature of between about 60° C. and 250° C., said uncooked food product comprising greater than about 5% to about 95% w/w type 1 resistant starch (RS1) and/or type 2 resistant starch (RS2), and wherein the moisture content of the uncooked food product is between about 2% and about 35% w/w. In some embodiments, the starch is modified according to the methods described herein.

In some embodiments, the initial uncooked food product may have a moisture content of greater than 35% w/w. In such cases, it will be necessary to reduce the moisture content of the uncooked food product to below 35% w/w. Thus, according to some embodiments, a method is provided for preparing a food product ready for consumption (e.g., cooked/heated) comprising about 5% to about 95% w/w w/w resistant starch, said method comprising heating an uncooked food product for a time sufficient to reduce the moisture content of the uncooked food product to below 35% w/w, said uncooked food product comprising about 5% to about 95% w/w starch granules in the native, ungelatinized, and/or semi-crystalline state (e.g., RS2), wherein the temperature at which the uncooked food product is heated is below the gelatinization temperature of the starch granules (e.g., 50° C.). The gelatinization temperature of starch is dependent upon plant type and is measured in an excess of water. In some embodiments, the uncooked food product is shaped (e.g., sheeted, shaped, cut, etc) prior to this moisture reduction step. In some embodiments, the uncooked food product is shaped (e.g., sheeted, shaped, cut, etc) after to the moisture reduction step. Once the moisture content of the uncooked food product is below 35% w/w, the uncooked food product may be heated at a temperature of between about 60° C. and 250° C. until cooked. The prepared food product comprises greater than about 5% to about 95% w/w starch granules in the native, ungelatinized, and/or semi-crystalline state.

In some embodiments, the starch of the food product is derived from a starch containing material. In some embodiments, the starch of the food product is derived from a tuber or grain. In some embodiments, the starch of the food product is derived from potato, corn, maize, rice, or wheat. In some embodiments, starch is modified according to the methods described herein.

According to some embodiments, there is provided a food product ready for human consumption comprising about 5% to about 95% w/w of its starch in the native, ungelatinized, and/or semi-crystalline state.

According to some embodiments, a method is provided for preparing a food product ready for consumption (e.g., cooked/heated) comprising about 5% to about 95% w/w w/w resistant starch, said method comprising heating an uncooked food product for a time sufficient to reduce the moisture content of the uncooked food product to below 35% w/w, said uncooked food product comprising about 5% to about 95% w/w type 2 resistant starch (RS2), wherein the temperature at which the uncooked food product is heated is below the gelatinization temperature of the starch granules (e.g., 50° C.). In some embodiments, the uncooked food product is shaped (e.g., sheeted, shaped, cut, etc) prior to this moisture reduction step. In some embodiments, the uncooked food product is shaped (e.g., sheeted, shaped, cut, etc) after to the moisture reduction step. Once the moisture content of the uncooked food product is below 35% w/w, the uncooked food product may be heated at a temperature of between about 60° C. and 250° C. until cooked. The prepared food product comprises greater than about 5% to about 95% w/w starch granules in the native, ungelatinized, and/or semi-crystalline state. In some embodiments, the starch is modified according to the methods described herein.

According to some embodiments, a method is provided for preparing a food product ready for consumption (e.g., cooked/heated) comprising about 5% to about 95% w/w w/w resistant starch, said method comprising heating an uncooked food product for a time sufficient to reduce the moisture content of the uncooked food product to below 35% w/w, said uncooked food product comprising about 5% to about 95% w/w type 1 resistant starch (RS1) and/or type 2 resistant starch (RS2), wherein the temperature at which the uncooked food product is heated is below the gelatinization temperature of the starch granules (e.g., 50° C.). In some embodiments, the uncooked food product is shaped (e.g., sheeted, shaped, cut, etc) prior to this moisture reduction step. In some embodiments, the uncooked food product is shaped (e.g., sheeted, shaped, cut, etc) after to the moisture reduction step. Once the moisture content of the uncooked food product is below 35% w/w, the uncooked food product may be heated at a temperature of between about 60° C. and 250° C. until cooked. The prepared food product comprises greater than about 5% to about 95% w/w starch granules in the native, ungelatinized, and/or semi-crystalline state. In some embodiments, the starch is modified according to the methods described herein.

According to some embodiments, a method is provided for preparing a food product ready for consumption (e.g., cooked/heated) comprising about 5% to about 95% w/w w/w resistant starch, said method comprising heating an uncooked food product for a time sufficient to reduce the moisture content of the uncooked food product to below 35% w/w, said uncooked food product comprising about 5% to about 95% w/w type 1 resistant starch (RS1), type 2 resistant starch (RS2), and/or type 3 resistant starch (RS3), wherein the temperature at which the uncooked food product is heated is below the gelatinization temperature of the starch granules (e.g., 50° C.). In some embodiments, the uncooked food product is shaped (e.g., sheeted, shaped, cut, etc) prior to this moisture reduction step. In some embodiments, the uncooked food product is shaped (e.g., sheeted, shaped, cut, etc) after to the moisture reduction step. Once the moisture content of the uncooked food product is below 35% w/w, the uncooked food product may be heated at a temperature of between about 60° C. and 250° C. until cooked. The prepared food product comprises greater than about 5% to about 95% w/w starch granules in the native, ungelatinized, and/or semi-crystalline state. In some embodiments, the starch is modified according to the methods described herein.

According to some embodiments, there is provided a cooked/heated/baked (e.g., not raw) food product ready for human consumption comprising greater than 5% w/w of its starch in the native, ungelatinized, and/or semi-crystalline state. In some embodiments, the starch is modified according to the methods described herein.

According to some embodiments, there is provided a method of preparing a food product comprising at least 5% w/w resistant starch, said method comprising heating a potato ingredient or potato material comprising greater than 5% w/w of its starch in the native, ungelatinized, and/or semi-crystalline state at a temperature of between about 60° C. and 250° C., wherein the moisture content of the RS potato tissue material or ingredient is between about 2% and about 35% w/w. In some embodiments, the starch is modified according to the methods described herein.

According to some embodiments, there is provided a potato-based food product ready for human consumption comprising greater than 5% w/w of its starch in the native, ungelatinized, and/or semi-crystalline state. In some embodiments, the starch is modified according to the methods described herein.

According to some embodiments, there is provided a cooked (e.g., not raw) potato-based food product ready for human consumption comprising greater than 5% w/w of its starch in the native, ungelatinized, and/or semi-crystalline state. In some embodiments, the starch is modified according to the methods described herein.

### BRIEF DESCRIPTION OF THE DRAWINGS

FIG. 1 provides a diagram of starch molecular and granule structure (From Chaplin, 2010).

FIG. 2. Within potato tissue, (a) ungelatinized starch granules within parenchyma cells, (b) undergo swelling and gelatinization during heating to exert a temporary “swelling pressure” on surrounding cell walls. With further heating, starch granules (c) lose both granule and molecular order to form a gelatinized starch mass, which is readily degraded by amylolytic enzymes (BeMiller and Huber, 2008).

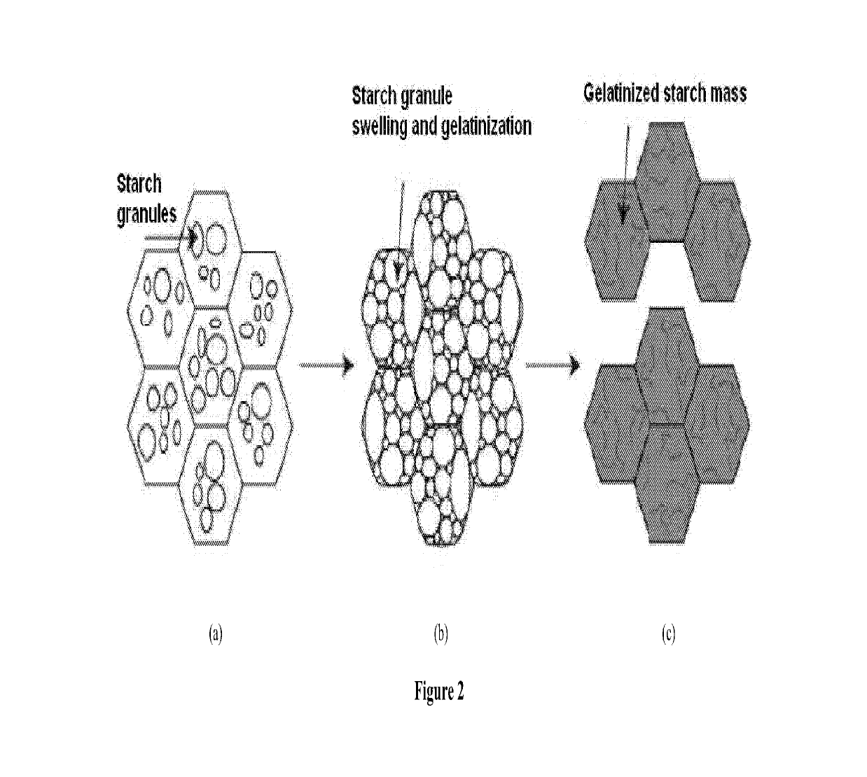

FIG. 3. Light micrograph of commercial potato granules consisting of intact potato parenchyma cells. Cell wall structures surround a mass of gelatinized starch (i.e., dark regions stained with iodine).

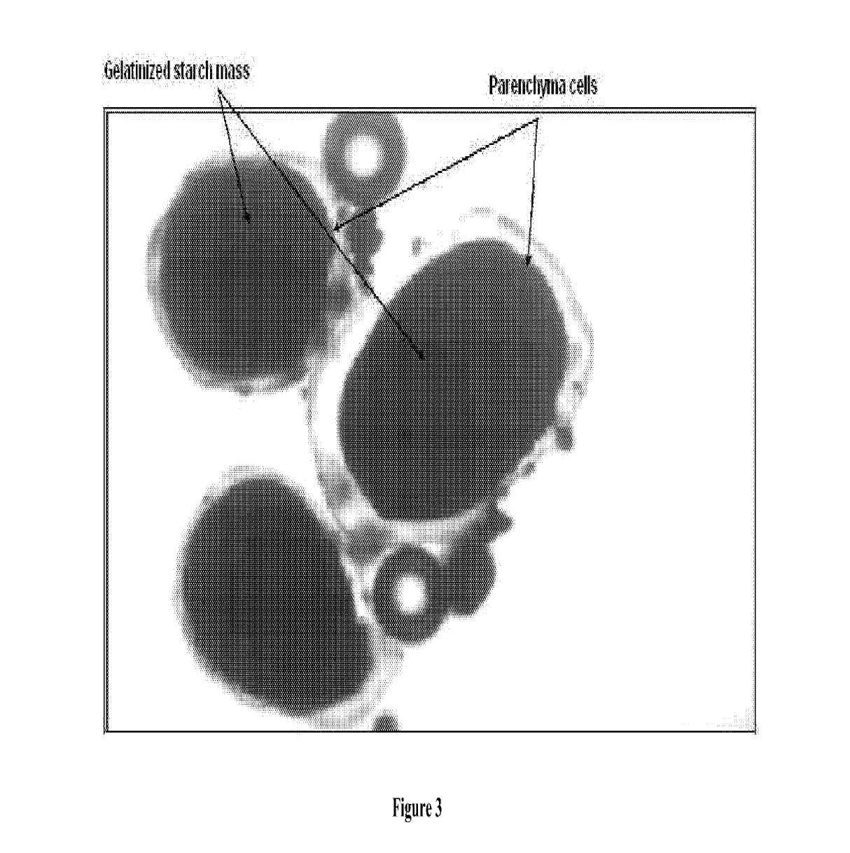

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Starch Structure and Chemistry in Relation to Glycemic Response

A brief overview of starch structure and chemistry will be provided to provide insight into the factors influencing starch availability and digestibility.

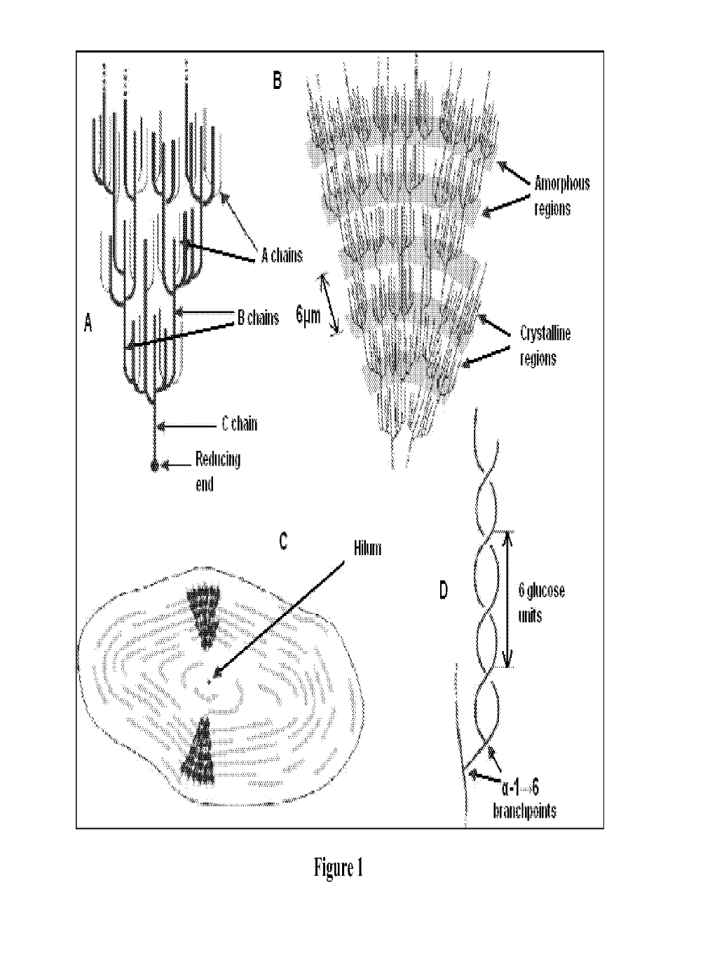

In its simplest form, starch consists exclusively of α-D-glucan, and is made up of two primary polymers, amylose and amylopectin. Amylose is predominantly a linear molecule containing ˜99% α-(1→4) and ˜1% a-(1→6) glycosidic bonds with a molecular weight of ˜10⁵-10⁶ (Bertoft, 2000). On average, amylose molecules possess a degree of polymerization (DP) of approximately 1000 anhydroglucose units (AGU), though DP varies according to botanical source. Amylopectin (molecular weight ˜10⁷-10⁸) is a much larger molecule than that of amylose, and is more heavily branched with ˜95% α-(1→4) and ˜5% α-(1→6) glycosidic linkages (Bertoft, 2000). The chains of amylopectin range from −12 to 120 AGU in length (Rutenberg and Solarek, 1984), and may be classified as either A, B, or C chains (FIG. 1A). The A chains are the outer or terminal branches, which themselves do not give further rise to other branch chains. In contrast, B chains are inner chains that give rise to one or more additional branch chains, while C chains house the only reducing end (free anomeric carbon) of the amylopectin molecule. Amylopectin molecules may contain upwards of two million glucose residues, and exhibit a compact branch-on-branch structure (Parker and Ring, 2001).

In plants, starch molecules are synthesized to form semi-crystalline aggregates, termed granules, which provide a means of storing carbohydrate in an insoluble and tightly packed manner (Imberty et al., 1991). The size (1-100 μm) and shape (spherical, polygonal, ellipsoidal, etc.) of starch granules varies among plant species, and also within cultivars of the same species (Baghurst et al., 1996). Starch granules consist of concentric growth rings of alternating hard and soft shells. While the structure of the soft shells is not precisely known due to their amorphous nature, the hard shells consist of an alternating 6 nm crystalline (comprising double-helical structures of amylopectin branch chains) and a 3 nm amorphous (comprising amylopectin branch point regions) repeat structure (FIGS. 1B and 1D). Amylopectin molecules, which are predominantly responsible for the native crystalline structure of starch granules, are oriented radially within granules with their non-reducing ends facing outward toward the granule exterior (FIG. 1C). Granule crystallinity limits the accessiblity of starch chains to amylolytic enzymes, as native starch granules are digested (i.e. hydrolyzed) very slowly. Amylose molecules are thought to be concentrated in the amorphous regions of starch granules, though their exact granular locale remains a subject of debate.

When starch granules are subjected to heat treatment in the presence of excess water, they undergo a process termed gelatinization (55-130° C. depending on the source of the starch), which involves a loss of granular crystallinity and molecular order, as well as a disruption of the granule structure. Over the course of gelatinization, intermolecular hydrogen bonds between starch molecules are disrupted, allowing greater interaction between starch and water. This penetration of water increases the randomness in the granular structure, and facilitates melting of the native crystalline structure (Donald, 2000). Upon cooling, retrogradation begins as the linear segments of polymer chains begin to reassociate in limited fashion to form a three-dimensional gel structure (Wu and Sarko, 1978). Once gelatinization has occurred, starch molecules become more susceptible to enzymatic hydrolysis, which was initially restricted by the crystalline nature of the native granule structure. Though some limited intermolecular reassociation (i.e., retrogradation) may take place, starch molecules do not regain the original molecular order of native granules (Donald, 2000).

### Resistant Starch (RS)/Slowly Digestible Starch (SDS)

The term “resistant starch” describes a small fraction of starch that was resistant to hydrolysis by exhaustive α-amylase and pullulanase treatment in vitro. However, from an in vivo perspective, resistant starch (RS) is scientifically defined as starch material escaping digestion by human enzymes present within the small intestine (Asp, 2001), leading to physiological benefits as it passes into the colon. It may be classified into four primary types (RS1, RS2, RS3 and RS4) based on the specific mode of resistance to digestion (Table 1) (Nugent, 2005).

TABLE 1
Primary Types and Characteristics of Resistant Starch (RS)

| Resistant Starch Type/Nature of Resistance | Food Example Type | Limitations |
|---|---|---|
| RS1: Starch physically shielded or | Whole kernel grains | Resistance to digestion may |
| protected from enzymes | | diminish with heating or |
| by a physical barrier (e.g. | | processing due to loss of |
| intact cell wall) | | integrity of the physical |
| | | barrier (e.g., cooked potatoes). |
| RS2: Native crystalline starch (amylo- | Raw vegetables | Loses resistance to |
| pectin double helical | | digestion with heating sufficient |
| structures) within | | bring about gelatinization. |
| ungelatinized | | |
| starch granules | | |
| RS3: Retrograded or re-crystallized | Resistant starch | Stable to high temperatures above |
| starch molecules (primarily | ingredients | 100° C., but does not contribute a |
| amylose or linear starch | | significant physical function (contributes |
| chains) formed by re- | | primarily bulking properties). |
| association following | | |
| gelatinization | | |
| RS4: Bulky chemical groups in- | Chemically modi- | Must be labeled as modified starch. |
| corporated onto starch | fied food starches | Contributes enhanced physical function in |
| chains physically impede | | accordance with the nature of |
| enzyme degradation | | modification. Resistance generally not |
| | | lost upon heating. |

Type 1 resistant starch (RS1) represents starch that remains undigested due to it being in a physically inaccessible form or being physically shielded from hydrolytic enzymes. Examples include partially milled grains and seeds and very dense processed starchy foods. Some grains or seeds remain intact after cooking due to a fibrous shell that continues to protect starch from enzyme digestion (Englyst and Cummings, 1987; Brown et al., 2001). However, most RS1 containing foods remain resistant only in the raw or uncooked state, as cooking can dramatically reduce the effectiveness of physical barriers that protect starch from hydrolytic enzymes (Asp, 1996).

Resistant starch, type 2, consists of native starch granules (ungelatinized starch), which exhibit a semi-crystalline structure that resists enzyme digestion. With the exception of high-amylose starches, most RS2 materials lose virtually all of their resistant characteristics when heated in excess water (i.e., gelatinized) (Englyst and Cummings, 1987; Englyst and kingman, 1990).

Type 3 resistant starches (RS3) consist of retrograded linear starch fractions (primarily amylose) comprised of double helical structures, and are formed by cooling and recrystallization of gelatinized starch chains (Englyst et al., 1992; Haralampu, 2000). Retrograded starch is highly resistant to digestion by pancreatic amylase, and retains its resistance to temperatures as high as 140-160° C. (Haralampu, 2000). However, the water holding capacity of RS3 can be relatively reduced due to extensive starch-starch interactions inherent to this type of RS (Sajilata et al., 2006).

Type 4 resistant starch (RS4) employs chemical modification, which introduces bulky substituent groups onto starch chains, increasing steric hindrance to enzyme hydrolysis. RS4 generally retains its resistance to digestion following heat processing, and may further contribute enhanced starch properties for food applications in accordance with the specific type of modification employed (Brown et al., 2001; Sajilata et al., 2006; Xie et al., 2006).

Much of the interest surrounding RS has to do with its potential physiological roles. Because RS escapes digestion in the small intestine, it serves as a source of fermentable carbohydrate for the bacterial microflora of the colon. As these microorganisms metabolize the carbohydrate material via fermentation, the colonic pH is lowered and short-chain fatty acids such as acetate, propionate, and butyrate, are released. Of these secondary metabolites, butyrate yield from RS is relatively high, and has been implicated in promoting colonic health (Van Munster et al., 1994; Baghurst et al., 1996; Johnson and Gee, 1996; Kendall et al., 2004). The presence of fermentable substrate helps prevent inflammatory bowel disease and maintains the metabolic requirements of the colonic mucosal cells. Johnson and Gee (1996) reported that butyrate decreases the proliferation/turnover of colonic mucosal cells, and may aid in suppressing the emergence of tumor cells. These factors are believed to contribute to a reduced risk of colon cancer. Results from rat feeding trials suggest that RS has a cholesterol-lowering function due to enhanced levels of hepatic SR-B1(scavenger receptor class B1) and cholesterol 7α-hydroxylase mRNA (Han et al., 2003). Resistant starch also has a prebiotic function, reduces gall stone formation, inhibits fat accumulation, and aids adsorption of minerals (Sajilata et al., 2006; Sharma et al., 2008).

Another potentially beneficial category of starch material is termed, slowly-digestible starch (SDS), which is generally fully degraded to glucose and absorbed during passage through the human small intestine, but at a moderated or reduced rate (Englyst et al., 1992; Bryan et al., 1999). In contrast to RS, slowly digestible starch contributes directly to blood glucose levels, but has a favorable impact on blood glucose homeostasis due to its prolonged time of digestion and gradual absorption within the small intestine (Englyst et al., 1992). Zhang and Hamaker (2009) indicated SDS can be impacted by the fine structure of amylopectin, especially the weight ratio of short to long starch chains. They further suggested that SDS is favored by either crystalline development among long linear branch chains during retrogradation or the preponderance of highly branched short chains (i.e., an increasing number of branch points slows digestion). Zhang and Hamaker (2009) reviewed potential benefits of SDS, associated with a slower the entry of glucose into the bloodstream and a moderated insulin response. Specific beneficial metabolic responses, which include moderated postprandial glucose levels, reduced episodes of hypoglycemia (i.e., overcompensation in response to a hyperlglycemic state), improved insulin response, and lower concentrations of glycosylated hemoglobin, are thought to provide improved satiety and mental performance.

As previously described, foods containing significant amounts of RS and SDS also have the potential to moderate the rate of glucose hydrolysis/uptake for control of glycemic response. The metabolism of RS takes place 5 to 7 hours after consumption, in comparison to normally cooked starch, which is digested almost immediately (Sajilata et al., 2006).

This phenomenon reduces postprandial glycemia and insulinemia and has potential for increasing the period of satiety between meals (Raben et al., 1994; Reader et al., 1997). Thus, in addition to the benefits RS contributes to colonic health, the same approach would also appear to be useful for moderation of the glycemic response of starch-containing foods.

Generally, RS is measured by enzymatic methods, which involve digestion of rapidly digestible starch, and quantitation of the indigestible starch residue. The fundamental step of any RS determination method for food must first remove all digestible starch from the sample using thermostable α-amylases or pancreatin enzymes (Englyst et al., 1992; McCleary and Rossiter, 2004; Shin et al., 2004). At present, two general strategies have been proposed to determine RS (Berry, 1986; Englyst et al., 1992). The in vitro RS determination of Englyst et al. (1992) has the advantage of having been correlated to actual human physiological conditions (in vivo), and is therefore able to determine both RS and SDS via the same assay

### Potato Granules as a Vehicle for a Whole-Tissue RS Food Ingredient

To date, virtually all commercial RS products have utilized isolated starch as the vehicle for generating RS/SDS starch materials, with little, if any, emphasis directed toward a whole food strategy. Dehydrated potato products (i.e., potato granules) would appear to represent a potential vehicle for development of a potato tissue-based RS ingredient (i.e., whole-tissue approach) due to their versatility as a food ingredient, excellent shelf-stability, cost-effective transportability, and existing commercial presence within existing markets.

Native potato tissue is generally comprised of two principal regions: the cortex and the pith. The cortex is made up of vascular storage parenchyma cells, which house vast amounts of starch granules. The pith tissue, which is located in the central region of the tuber, also consists of parenchyma cells, but contains a slightly lower density of starch (Jadhav and Kadam, 1998). Parenchyma primary cell wall structures are comprised primarily of cellulose, hemicellulose (e.g., xyloglucans, heteromannans, heteroxylans), and pectic substances (Parker et al., 2001). Pectic substances, which are located in the middle lamellae (intercellular space), play a major role in intercellular adhesion, and also contribute to the mechanical strength of the cell wall (Van Marie et al., 1997). Within the native tissue, potato starch granules (ungelatinized state) are extremely resistant to human digestion due to their native crystalline structure.

According to some embodiments, there is provided a method for reducing the glycemic response values of a whole-tissue potato product comprising contacting a whole-tissue potato substrate with an aqueous solution of an etherifying agent at a temperature between 22° C. and 70° C., thereby reducing the glycemic response value of the potato product.

According to some embodiments, there is provided a method for reducing the glycemic response values of a whole-tissue potato product comprising contacting a whole-tissue potato substrate with an esterifying agent, thereby reducing the glycemic response value of the potato product.

According to some embodiments, there is provided a method for reducing the glycemic response values of a whole-tissue potato product comprising: contacting a whole-tissue potato substrate with an aqueous solution of an etherifying agent at a temperature between 22° C. and 70° C.; and/or contacting the potato substrate with an esterifying agent, thereby reducing the glycemic response value of the potato product.

In some embodiments, the glycemic response value for the whole-tissue potato product produced by the present invention is reduced by at least 5 points (e.g., at least 5 points, at least 10 points, at least 15 points, at least 20 points, at least 25 points, at least 30 points, at least 6 points, at least 7 points, at least 8 points, at least 9 points, at least 12 points, at least 18 points, at least 22 points).

In some embodiments, the glycemic response value for the whole-tissue potato product produced by the present invention is below 70. This includes glycemic response values below 69, below 68, below 67, below 66, below 65, below 64, below 63, below 62, below 61, below 60, below 59, below 58, below 57, below 56, below 55, below 54, below 53, below 52, below 51, below 50, or below 45).

In some the glycemic response value for the whole-tissue potato product produced by the present invention is between 40 and 70 (e.g., between 40 and 70, between 40 and 65, between 40 and 60, between 40 and 55, between 40 and 50, between 40 and 45, between 45 and 70, between 45 and 65, between 45 and 60, between 45 and 55, between 45 and 50, between 50 and 70, between 50 and 65, between 50 and 60, between 50 and 55,between 55 and 70, between 55 and 65, between 55 and 60, between 50 and 64, between 50 and 63, between 50 and 62, between 50 and 61, between 50 and 59, between 50 and 58, between 50 and 57, between 50 and 56, between 50 and 54, between 52 and 64, between 52 and 63, between 52 and 62, between 52 and 61, between 52 and 59, between 52 and 58, between 52 and 57, between 52 and 56, between 52 and 54, between 54 and 64, between 54 and 63, between 54 and 62, between 54 and 61, between 54 and 59, between 54 and 58, between 54 and 57, between 54 and 56, between 56 and 64, between 56 and 63, between 56 and 62, between 56 and 61, between 56 and 59, and between 56 and 58).

### Methods of Preparing Whole-Tissue Potato Products

According to some embodiments, there is provided a method of preparing potato products with enhanced resistant starch (RS) content comprising contacting a whole-tissue potato substrate with an aqueous solution of an etherifying agent at a temperature between 22° C. and 70° C., thereby increasing the RS content of the potato product.

According to some embodiments, there is provided a method of preparing potato products with enhanced resistant starch (RS) content comprising contacting a whole-tissue potato substrate with an esterifying agent, thereby increasing the RS content of the potato product.

According to some embodiments, there is provided a method of preparing potato products with enhanced resistant starch (RS) content comprising: contacting a whole-tissue potato substrate with an aqueous solution of an etherifying agent at a temperature between 22° C. and 70° C.; and/or contacting the potato substrate with an esterifying agent, thereby increasing the RS content of the potato product.

According to some embodiments, there is provided a method of modifying potato cell wall constituents and/or starch within intact potato cells, to increase the enhanced resistant starch (RS) therein, comprising: contacting a whole-tissue potato substrate with an aqueous solution of an etherifying agent at a temperature between 22° C. and 70° C. thereby modifying the potato cell wall constituents and/or starch within intact potato cells.

According to some embodiments, there is provided a method of modifying potato cell wall constituents and/or starch within intact potato cells, to increase the enhanced resistant starch (RS) therein, comprising: contacting a whole-tissue potato substrate with an esterifying agent, thereby modifying the potato cell wall constituents and/or starch within intact potato cells.

According to some embodiments, there is provided a method of modifying potato cell wall constituents and/or starch within intact potato cells, to increase the enhanced resistant starch (RS) therein, comprising: contacting a whole-tissue potato substrate with an aqueous solution of an etherifying agent at a temperature between 22° C. and 70° C.; and contacting the potato substrate with an esterifying agent, thereby modifying the potato cell wall constituents and/or starch within intact potato cells.

According to some embodiments, there is provided a method of increasing resistance of modified potato products to starch retrogradation comprising: contacting a whole-tissue potato substrate with an aqueous solution of an etherifying agent at a temperature between 22° C. and 70° C., thereby increasing the resistance of modified potato products to starch retrogradation.

According to some embodiments, there is provided a method of increasing resistance of modified potato products to starch retrogradation comprising: contacting a whole-tissue potato substrate with an esterifying agent, thereby increasing the resistance of modified potato products to starch retrogradation.

According to some embodiments, there is provided a method of increasing resistance of modified potato products to starch retrogradation comprising contacting a whole-tissue potato substrate with an aqueous solution of an etherifying agent at a temperature between 22° C. and 70° C.; and/or contacting the potato substrate with an esterifying agent, thereby increasing the resistance of modified potato products to starch retrogradation.

According to some embodiments, there is provided a potato product with enhanced resistant starch (RS) content comprising a potato ingredient made by the process of contacting a whole-tissue potato substrate with an aqueous solution of an etherifying agent at a temperature between 22° C. and 70° C.

According to some embodiments, there is provided a potato product with enhanced resistant starch (RS) content comprising a potato ingredient made by the process of contacting a whole-tissue potato substrate with an esterifying agent.

According to some embodiments, there is provided a potato product with enhanced resistant starch (RS) content comprising a potato ingredient made by the process of contacting a whole-tissue potato substrate with an aqueous solution of an etherifying agent at a temperature between 22° C. and 70° C. and/or contacting the potato substrate with an esterifying agent.

The potato products of the present embodiments may have a RS content of between 5% to 70%. This includes, but is not limited to, a RS content of between 5% to 70%, between 10% to 70%, between 15% to 70%, between 20% to 70%, between 25% to 70%, between 30% to 70%, between 35% to 70%, between 40% to 70%, between 45% to 70%, between 50% to 70%, between 55% to 70%, between 60% to 70%, between 65% to 70%, between 5% to 60%, between 10% to 60%, between 15% to 60%, between 20% to 60%, between 25% to 60%, between 30% to 60%, between 35% to 60%, between 40% to 60%, between 45% to 60%, between 50% to 60%, between 55% to 60%, between 5% to 50%, between 10% to 50%, between 15% to 50%, between 20% to 50%, between 25% to 50%, between 30% to 50%, between 35% to 50%, between 40% to 50%, between 45% to 50%, between 5% to 40%, between 10% to 40%, between 15% to 40%, between 20% to 40%, between 25% to 40%, between 30% to 40%, between 35% to 40%, between 5% to 30%, between 10% to 30%, between 15% to 30%, between 20% to 30%, between 25% to 30%, between 5% to 20%, between 10% to 20%, and between 15% to 20%.

One aspect of the present invention is the development of a multifunctional potato granule ingredient with enhanced RS content and moderated rates of starch digestibility for utilization in food systems (snack foods, extruded French fries/potato pieces, dehydrated mashed potato products, bakery products, etc.). The present invention provides methods described by which potato products are chemically modified to yield novel potato-based food products/ingredients. Under the described processing conditions, potato material is treated with chemical modifying agents (substitution and/or cross-linking agents) approved to modify starch for use in food.

It is one aspect of the present invention to modify (chemically) a whole-tissue potato substrate (cell wall constituents and/or starch within intact potato cells) using food approved reagents to produce novel modified products with enhanced RS content and moderated rates of starch digestibility. Preferably, whole-tissue potato substrates have an enhanced content type 4 resistant starch (RS4) through chemical modification of starch within cell wall constituents and/or starch within intact potato cells.

In some embodiments, reactions are carried out under basic pH conditions within an aqueous isopropanol ethanol slurry. Because of the pattern of chemical substituent groups incorporated onto starch polymers, a portion of the starch (amount varies according to reaction conditions used) within potato material becomes resistant to full digestion by amylolytic enzymes. Thus, the generated potato products/ingredients represent a source of resistant starch (RS) (type 4), and also exhibit a reduced extent of enzyme hydrolysis (i.e., reduced glycemic attribute) compared to unreacted controls.

In some embodiments, the potato products/ingredients of the present invention have uses in food products including, but not limited to existing applications of commercial potato ingredients (e.g., granules, flakes, flours, etc.) with the added advantage of contributing an enhanced RS content and/or a moderated glycemic response to such food products. Thus, the unique attributes (moderation of glycemic response and increased RS content) of these novel potato ingredients/products also make them suitable for formulation of specialty food products, including those intended for diabetics or formulated to enhance colonic health. Additionally, the methods described for processing the novel potato ingredients/products may also prove useful for enhancement of traditional mashed potato and potato flake, flour and/or granule processing. In some embodiments, the modified potato ingredients/products exhibit benefits similar to those of chemically modified starches (e.g., reduced starch retrogradation).

According to some embodiments, there is provided a method of preparing potato products with enhanced resistant starch (RS) content comprising: contacting a whole-tissue potato substrate with an aqueous solution of an etherifying agent at a temperature between 22° C. and 70° C.; and/or contacting the potato substrate with an esterifying agent, thereby increasing the RS content of the potato product.

According to some embodiments, there is provided a method of modifying potato cell wall constituents and/or starch within intact potato cells, to increase the enhanced resistant starch (RS) therein, comprising: contacting a whole-tissue potato substrate with an aqueous solution of an etherifying agent at a temperature between 22° C. and 70° C.; and/or contacting the potato substrate with an esterifying agent, thereby modifying the potato cell wall constituents and/or starch within intact potato cells.

According to some embodiments, there is provided a method of increasing resistance of modified potato products to starch retrogradation comprising contacting a whole-tissue potato substrate with an aqueous solution of an etherifying agent at a temperature between 22° C. and 70° C.; and/or contacting the potato substrate with an esterifying agent, thereby increasing the resistance of modified potato products to starch retrogradation.

According to some embodiments, there is provided a method for reducing the glycemic response values of a whole-tissue potato product comprising: contacting a whole-tissue potato substrate with an aqueous solution of an etherifying agent at a temperature between 22° C. and 70° C.; and/or contacting the potato substrate with an esterifying agent, thereby reducing the glycemic response value of the potato product.

A potato product with enhanced resistant starch (RS) content comprising a potato ingredient made by the process of contacting a whole-tissue potato substrate with an aqueous solution of an etherifying agent at a temperature between 22° C. and 70° C. and/or contacting the potato substrate with an esterifying agent.

In some embodiments, the potato substrate is a dehydrated potato substrate. In some embodiments, potato substrate is a flake, granule, or flour. In some embodiments, the potato substrate is in the form of peeled potatoes, potato slices, potato cubes, potato dices, potato shreds, potato wedges, or potato sticks.

The temperature for the etherifying step may be from between 22° C. and 70° C. For example, the temperature for the etherifying step may be from between 30° C. and 55° C., between 40° C. and 50° C., or between 45° C. and 50° C.

The temperature for the esterifying step may be from between 22° C. and 70° C. For example, the temperature for the esterifying step may be from between 30° C. and 55° C., between 40° C. and 50° C., or between 45° C. and 50° C.

In some embodiments, the etherifying agent may be selected from one or more of the following: propylene oxide, acrolein, epichlorohydrin, epichlorohydrin and propylene oxide, epichlorhydrin and acetic anhydride, and epichlorohydrin and succinic anhydride and mixtures and combinations thereof. The amount of etherifying agent used is between 0.5% and 35% [w/w] based on potato substrate dry weight.

The etherifying step may be conducted under acidic or basic conditions. Basic conditions are preferred. For example, the etherifying step may performed at a pH between 8 and 14 (e.g. between 10 and 14).

In some embodiments, the esterifying agent may be selected from one or more of the following: trimetaphosphate (STMP), sodium tripolyphosphate (STPP), phosphorus oxychloride, and epichlorohydrin. In some embodiments, the esterifying agent may be selected from one or more of the following: acetic anhydride, adipic anhydride, adipic anhydride and acetic anhydride, vinyl acetate, monosodium orthophosphate, 1-octenyl succinic anhydride, succinic anhydride, phosphorus oxychloride, phosphorus oxychloride and vinyl acetate, phosphorus oxychloride and acetic anhydride, sodium trimetaphosphate and sodium tripolyphosphate, sodium tripolyphosphate, and sodium trimetaphosphate. The amount of esterifying agent used is between 0.5% and 35% [w/w] based on potato substrate dry weight.

The esterifying step may be conducted under acidic or basic conditions. Basic conditions are preferred. For example, the esterifying step may performed at a pH between 8 and 14 (e.g. between 10 and 14).

In some embodiments, the methods of the present embodiments comprise contacting a whole-tissue potato substrate with an aqueous alcohol solution of an etherifying agent at a temperature between 22° C. and 70° C. In some embodiments, the methods of the present embodiments comprise contacting a whole-tissue potato substrate with an aqueous alcohol solution of an etherifying agent under basic conditions at a temperature between 22° C. and 70° C. The alcohol may be one or more of an alkyl alcohol including, but not limited to, methanol, ethanol, propanol, isopropanol, and butanol. In some embodiments, the potato substrate is heated to a temperature of between 30° C. and 70° C. in the presence of aqueous isopropanol or ethanol.

According to some embodiments, there is provided a composition comprising a whole tissue potato product having a RS content of 8% to 70%. In some embodiments, there is provided a composition comprising a whole tissue potato product having a type 4 resistant starch (RS4) content of 8% to 70%. The potato product may be a potato flake, potato granule, or potato flour. The potato product may be dehydrated. In some embodiments, the potato product is in the form of peeled potatoes, potato slices, potato cubes, potato dices, potato shreds, potato wedges, or potato sticks. The potato product may be a medicinal food potato product having an RS content of 8% to 70%. The potato product may be a medicinal food potato product having an RS4 content of 8% to 70%. In some embodiments, the glycemic response value of the potato product is below 70 (e.g. between 40 and 70 such as below 65, below 60, below 55, below 50, below 45). In some embodiments, the glycemic response value of the medicinal food potato product is below 70 (e.g., between 40 and 70 such as below 65, below 60, below 55, below 50, below 45).

### Aqueous Solutions

In some embodiments, the etherifying and/or esterifying steps are performed by contacting a whole-tissue potato substrate with an aqueous alcohol solution thereby forming a suspension or slurry. The etherifying and/or esterifying steps may be performed under acidic, neutral or basic conditions at a temperature between 22° C. and 70° C. The alcohol may be one or more of an alkyl alcohol including, but not limited to, methanol, ethanol, propanol, isopropanol, and butanol. Preferably, the alchohol is present at a level between 25% and 100% [v/v] (e.g., between 30%, 40%, 50%, 60%, 70%, 80%, or 90% to 100%).

### Temperature

In some embodiments, the temperature of the etherifying step and/or the esterifying is between 22° C. and 70° C. In some embodiments, the temperature of the etherifying step and/or the esterifying is between 22° C. and 40° C., between 30° C. and 60° C., or between 40° C. and 70° C.

### Potato Substrate

According to some embodiments, the starting material for the methods of the present invention is a whole-tissue potato substrate. A whole-tissue potato substrate material is produced from the flesh of the potato. In some embodiments, the whole-tissue substrate material comprises the majority of native dry solids contained in a native potato. Native dry solids contains the lipid, protein, carbohydrate (e.g., starch, fiber, and sugars), and ash of the native potato. In some embodiments, the potato substrate is a potato product/ingredient that contains at least 20% of the dry solids of a native potato (e.g. at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 97%, or at least 98% of the dry solids of a native potato). A whole-tissue potato substrate is distinct from an isolated starch product.

In some embodiments, the whole-tissue potato substrate comprises existing commercial potato product (e.g. potato granules) that exhibits an intact parenchyma cell wall structure for use as a starting material for development of the potato products/ingredients of the present invention.

In some embodiments, the whole-tissue potato substrate comprises potato flakes, potato granules, or potato flours for use as a starting material for development of the potato products/ingredients of the present invention.

In some embodiments, the whole-tissue potato substrate is a dehydrated whole-tissue potato product. In other embodiments, the whole-tissue potato product may be in the form of peeled potatoes, potato slices, potato cubes, potato dices, potato shreds, potato wedges, or potato sticks, which may or may not be dehydrated.

In some embodiments, the potato substrate is a potato product/ingredient that contains at least 20% intact parenchyma cells (e.g. at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 97%, or at least 98%).

### Etherifying Agent

The etherifying agent may be any agent known to be capable of producing starch ethers. In some embodiments, the etherifying agent is one or more of propylene oxide, acrolein, epichlorohydrin, epichlorohydrin and propylene oxide, epichlorhydrin and acetic anhydride, and epichlorohydrin and succinic anhydride, including all mixtures and combinations of these agents.

The amount of etherifying agent used may be between 0.5% and 35% [w/w] based on potato substrate dry weight. The amount of etherifying agent used may be between between 1% and 15% [w/w], between 10% and 25% [w/w], or between 20% and 35% [w/w], based on potato substrate dry weight.

The etherifying step may be performed under acidic, neutral or basic conditions at a temperature between 22° C. and 70° C. In some embodiments, is performed under basic condition such as at a pH greater than or equal to 8 (e.g., a pH between 8 and 14). This includes a pH above pH 8.5, above pH 9, above pH 9.5, above pH 10, above pH 10.5, above pH 11, above pH 11.5, above pH 12, above pH 12.5, above pH 13.5, or above pH 13.5. In some embodiments, the pH is between 10 and 14 (e.g. between 11 and 14, between 12 and 14, between 13 and 14).

### Esterifying Agent

The esterifying agent may be any agent known to be capable of producing starch esters. In some embodiments, the esterifying agent is one or more of trimetaphosphate (STMP), sodium tripolyphosphate (STPP), phosphorous oxychloride, and epichlorohydrin, including all mixtures and combinations of these agents. In some embodiments, the esterifying agent is one or more acetic anhydride, adipic anhydride, adipic anhydride and acetic anhydride, vinyl acetate, monosodium orthophosphate, 1-octenyl succinic anhydride, succinic anhydride, phosphorus oxychloride, phosphorus oxychloride and vinyl acetate, phosphorus oxychloride and acetic anhydride, sodium trimetaphosphate and sodium tripolyphosphate, sodium tripolyphosphate, and sodium trimetaphosphate, including all mixtures and combinations of these agents.

The amount of esterifying agent used may be between 0.5% and 35% [w/w] based on potato substrate dry weight. The amount of esterifying agent used may be between between 1% and 15% [w/w], between 10% and 25% [w/w], or between 20% and 35% [w/w] based on potato substrate dry weight.

The esterifying step may be performed under acidic, neutral or basic conditions at a temperature between 22° C. and 70° C. In some embodiments, is performed under basic condition such as at a pH greater than or equal to 8 (e.g., a pH between 8 and 14). This includes a pH above pH 8.5, above pH 9, above pH 9.5, above pH 10, above pH 10.5, above pH 11, above pH 11.5, above pH 12, above pH 12.5, above pH 13.5, or above pH 13.5. In some embodiments, the pH is between 10 and 14 (e.g. between 11 and 14, between 12 and 14, between 13 and 14).

### Preparation of Food Products Containing RS Food Ingredients

According to some embodiments, the present invention provides a food composition ready for consumption having an enhanced resistant starch content of about 5% to about 95% w/w (e.g., at least about 5%, 10%, 15%, 20%, 25%, 30%, 40%, 50%, 60%, 70%, or 80% w/w). The food composition may be made using a food ingredient comprising resistant starch, such as chemically modified or unmodified starch granules. The food composition may be made using a food ingredient comprising about 5% to about 95% w/w starch granules in the native state. The food composition may be made using a food ingredient comprising about 5% to about 95% w/w starch granules in the ungelatinized and/or semi-crystalline state. The food composition may be made using a food ingredient comprising about 5% to about 95% w/w starch granules in the native, ungelatinized and/or semi-crystalline state. The food composition may be made using a food ingredient comprising at least about 5% to about 95% w/w type 2 resistant starch (RS2). The food composition may be made using a food ingredient comprising at least about 5% to about 95% w/w type 1 resistant starch (RS1) and/or type 2 resistant starch (RS2). The food composition may be made using a food ingredient comprising at least about 5% to about 95% w/w type 1 resistant starch (RS1), type 2 resistant starch (RS2), and/or type 3 resistant starch (RS3).

According to some embodiments, a method is provided for preparing a food product comprising about 5% to about 95% w/w resistant starch, said method comprising heating an uncooked food product at a temperature of between about 60° C. and 250° C., said food product comprising starch granules, wherein about 5% to about 95% w/w of the starch granules are in the native, ungelatinized and/or semi-crystalline state, and wherein the starch moisture content of the food ingredient is between about 5% and about 35% w/w.

According to some embodiments, a method is provided for preparing a food product comprising about 5% to about 95% w/w resistant starch, said method comprising heating an uncooked food product to reduce the moisture content of the food product to below 35% w/w, wherein the temperature at which the uncooked food product is heated is below the gelatinization temperature of the starch granules (e.g., below 35° C., below 40° C., below 45° C., below 50° C., below 55° C., below 60° C., below 65° C., below 70° C., below 75° C., below 80° C., below 85° C., below 90° C., below 95° C., below 100° C., below 110° C., below 115° C., below 120° C., below 125° C., below 130° C., or below 135° C.). The gelatinization temperature of starch is dependent on plant type and is measured an excess of water. In some embodiments, the uncooked food product is shaped (e.g., sheeted, shaped, cut, etc) prior to this moisture reduction step. In some embodiments, the uncooked food product is shaped (e.g., sheeted, shaped, cut, etc) after to the moisture reduction step. In some embodiments, the starch granules are modified according to the methods described herein.

Once the moisture content of the uncooked food product is below 35% w/w, the food product may then be heated (e.g., baked, fried, etc.) at a temperature of between about 60° C. and 250° C. until cooked, as described herein.

In some embodiments, the food product is derived from a food source containing starch, wherein the starch granules are retained in the native (ungelatinized and/or semi-crystalline) state. Food ingredients (i.e. source materials for resistant starch such as RS2) comprising resistant starch may be used in the low-moisture food application according to the present invention. The resistant starch may be derived from any known source of edible starch. In some embodiments, the source of resistant starch is derived from potato, corn, rice, maize, wheat and combinations and mixtures thereof. In some embodiments, the resistant starch is starch is modified according to the methods described herein.

According to some embodiments, food ingredients may be a whole-tissue, food material (potato, corn, rice, maize, wheat, and combinations and mixtures thereof) or flour, granules, flakes, isolated starch thereof, wherein the starch granules retain the native (ungelatinized and/or semi-crystalline) state. In some embodiments, food ingredients comprise starch modified according to the methods described herein.

In some embodiments, the source of resistant starch may be a starch having an apparent amylose content of about 5% to about 85% (e.g., 10% to 70%, 20% to 70%, 30% to 70%, 40% to 70%, 50% to 70%, or 60% to 70%, 10% to 85%, 20% to 85%, 30% to 85%, 40% to 85%, 50% to 85%, or 60% to 85%) the starch being incorporated into a food composition as appropriate. Alternatively, grains or legumes or parts thereof that include starch of this amylose content may be used.

The starches used in the methods of the present invention may be any native starch derived from any native source. The starches used in the methods of the present invention may be any native amylose-containing or waxy starch derived from any native source. Typical sources for the starches are cereals, tubers, roots, legumes and fruits. The native source can be corn, pea, potato, sweet potato, banana, barley, wheat, rice, sago, amaranth, tapioca, arrowroot, canna, sorghum, and high-amylose varieties thereof.

In some embodiments, the food ingredient is derived from a tuber or grain. In some embodiments, the food ingredient is derived from potato, corn, maize, rice, or wheat.

According to some embodiments, food ingredients include a whole-tissue, potato material with starch granules retained in the native (semi-crystalline/ungelatinized) state. The food ingredient may be produced by any method known in the art or described herein. The food ingredient may take the form of potatoes, potato granules, potato flakes, and potato flour. For example, the whole tissue potato material may be generated by taking raw potato tissue, with minimal heat processing (e.g., below the gelatinization temperature of the starch granules), is processed to yield a potato-based food product/ingredient. Under the described processing conditions, the potato tissue slurry may be maintained in pumpable (i.e., low viscosity) form; an intact parenchyma cell structure may or may not be retained, depending on the degree of shear utilized during this and subsequent processing steps (e.g., grinding). Alternatively, the RS potato tissue material or ingredient may be generated via reconstitution of any of the individual potato tissue constituents (ungelatinized starch, protein, lipid, etc.) to form a composite product. In short, the RS potato ingredient has a similar composition to existing commercial potato ingredients (i.e., potato granules, flakes, flours), except it contains a portion of (e.g., greater than 5%) or all of its starch in the native, ungelatinized, and/or semi-crystalline state. Due to its physical state, the starch within this novel ingredient is highly resistant to human digestion. Thus, the potato ingredient may be classified as a type 1 (if intact parenchyma cell structure is present) and/or type 2 resistant starch (RS) material. In some embodiments, the resistant starch is starch is modified according to the methods described herein.

Importantly, the starting material for the methods of preparing a food composition having enhanced resistant starch is an ingredient comprising resistant starch. In some embodiments, the source of resistant starch may be a starch having a resistant starch content of 5% or more, the starch being incorporated into a food composition as appropriate. According to some embodiments, the RS food ingredients of the present embodiments may comprise between about 5% to 95% w/w of its starch in the native, ungelatinized, and/or semi-crystalline state. According to some embodiments, the RS food ingredients of the present embodiments may comprise between about 5% to 95% w/w ungelatinized resistant starch. According to some embodiments, the RS food ingredients of the present embodiments may comprise between about 5% to 95% w/w resistant starch. In some embodiments, the resistant starch is starch is modified according to the methods described herein.

The term “between about 5% to 95%” includes from about 5% to about 95%, from about 5% to about 90%, from about 5% to about 85%, from about 5% to about 80%, from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 30%, from about 5% to about 25%, from about 5% to about 20%, from about 5% to about 15%, from about 5% to about 10%, from about 10% to about 95%, from about 10% to about 90%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 10% to about 25%, from about 10% to about 20%, from about 10% to about 15%, from about 20% to about 95%, from about 20% to about 90%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 20% to about 35%, from about 20% to about 30%, from about 20% to about 25%, from about 30% to about 95%, from about 30% to about 90%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 30% to about 45%, from about 30% to about 40%, from about 30% to about 35%, from about 40% to about 95%, from about 40% to about 90%, from about 40% to about 85%, from about 40% to about 80%, from about 40% to about 75%, from about 40% to about 70%, from about 40% to about 65%, from about 40% to about 60%, from about 40% to about 55%, from about 40% to about 50%, from about 40% to about 45%, from about 50% to about 95%, from about 50% to about 90%, from about 50% to about 85%, from about 50% to about 80%, from about 50% to about 75%, from about 50% to about 70%, from about 50% to about 65%, from about 50% to about 60%, from about 50% to about 55%, from about 60% to about 95%, from about 60% to about 90%, from about 60% to about 85%, from about 60% to about 80%, from about 60% to about 75%, from about 60% to about 70%, from about 60% to about 65%, from about 70% to about 95%, from about 70% to about 90%, from about 70% to about 85%, from about 70% to about 80%, from about 70% to about 75%, from about 80% to about 95%, from about 80% to about 90%, from about 80% to about 85%, and from about 90% to about 95%. The starch may be free (isolated) potato starch or starch contained within whole-tissue potato RS ingredients.

According to some embodiments, a method is provided for preparing a food product ready for consumption (e.g., cooked/heated) comprising about 5% to about 95% w/w resistant starch. The method comprises preparing a food product comprising heating RS material at a temperature of between about 60° C. to 250° C. wherein the starch moisture content of the RS material is between about 2% to 35% w/w. The RS food ingredient may be exposed to the above conditions for a period of 1 minute to 4 hours (e.g., 5 min. 10 min., 15 min., 20 min., 30 min., 45 min., 60 min., etc.). The methods of the present embodiments, thus utilize a food ingredient that possesses starch in its native, ungelatinized, and/or semi-crystalline state (e.g., digestion-resistant) state, and processes it under conditions of temperature and moisture that allow the starch native (resistant) state to be partially or fully retained or enhanced (e.g., generation of RS3). Thus, starch in these applications is not readily digested or absorbed within the human digestive tract.

According to some embodiments, the temperature at which the RS material or food ingredient is heated is between about 60° C. to 250° C., which includes between about 60° C. to 250° C., between about 60° C. to 245° C., between about 60° C. to 240° C., between about 60° C. to 235° C., between about 60° C. to 230° C., between about 60° C. to 225° C., between about 60° C. to 220° C., between about 60° C. to 215° C., between about 60° C. to 210° C., between about 60° C. to 205° C., between about 60° C. to 200° C., between about 60° C. to 195° C., between about 60° C. to 185° C., between about 60° C. to 180° C., between about 60° C. to 175° C., between about 60° C. to 165° C., between about 60° C. to 160° C., between about 60° C. to 155° C., between about 60° C. to 150° C., between about 60° C. to 145° C., between about 60° C. to 140° C., between about 60° C. to 135° C., between about 60° C. to 130° C., between about 60° C. to 135° C., between about 60° C. to 125° C., between about 60° C. to 120° C., between about 60° C. to 115° C., between about 60° C. to 110° C., between about 70° C. to 110° C., between about 80° C. to 110° C., between about 90° C. to 110° C., between about 100° C. to 110° C., between about 100° C. to 250° C., between about 100° C. to 245° C., between about 100° C. to 240° C., between about 100° C. to 235° C., between about 100° C. to 230° C., between about 100° C. to 225° C., between about 100° C. to 220° C., between about 100° C. to 215° C., between about 100° C. to 210° C., between about 100° C. to 205° C., between about 100° C. to 200° C., between about 100° C. to 195° C., between about 100° C. to 185° C., between about 100° C. to 180° C., between about 100° C. to 175° C., between about 100° C. to 165° C., between about 100° C. to 160° C., between about 100° C. to 155° C., between about 100° C. to 150° C., between about 100° C. to 145° C., between about 100° C. to 140° C., between about 100° C. to 135° C., between about 100° C. to 130° C., between about 100° C. to 135° C., between about 100° C. to 125° C., between about 100° C. to 120° C., between about 100° C. to 115° C., between about 100° C. to 110° C., between about 110° C. to 250° C., between about 110° C. to 245° C., between about 110° C. to 240° C., between about 110° C. to 235° C., between about 110° C. to 230° C., between about 110° C. to 225° C., between about 110° C. to 220° C., between about 110° C. to 215° C., between about 110° C. to 210° C., between about 110° C. to 205° C., between about 110° C. to 200° C., between about 110° C. to 195° C., between about 110° C. to 185° C., between about 110° C. to 180° C., between about 110° C. to 175° C., between about 110° C. to 165° C., between about 110° C. to 160° C., between about 110° C. to 155° C., between about 110° C. to 150° C., between about 110° C. to 145° C., between about 110° C. to 140° C., between about 110° C. to 135° C., between about 110° C. to 130° C., between about 110° C. to 135° C., between about 110° C. to 125° C., between about 110° C. to 120° C., between about 110° C. to 115° C., between about 120° C. to 250° C., between about 120° C. to 245° C., between about 120° C. to 240° C., between about 120° C. to 235° C., between about 120° C. to 230° C., between about 120° C. to 225° C., between about 120° C. to 220° C., between about 120° C. to 215° C., between about 120° C. to 210° C., between about 120° C. to 205° C., between about 120° C. to 200° C., between about 120° C. to 195° C., between about 120° C. to 185° C., between about 120° C. to 180° C., between about 120° C. to 175° C., between about 120° C. to 165° C., between about 120° C. to 160° C., between about 120° C. to 155° C., between about 120° C. to 150° C., between about 120° C. to 145° C., between about 120° C. to 140° C., between about 120° C. to 135° C., between about 120° C. to 130° C., between about 120° C. to 135° C., between about 120° C. to 125° C., between about 130° C. to 250° C., between about 130° C. to 245° C., between about 130° C. to 240° C., between about 130° C. to 235° C., between about 130° C. to 230° C., between about 130° C. to 225° C., between about 130° C. to 220° C., between about 130° C. to 215° C., between about 130° C. to 210° C., between about 130° C. to 205° C., between about 130° C. to 200° C., between about 130° C. to 195° C., between about 130° C. to 185° C., between about 130° C. to 180° C., between about 130° C. to 175° C., between about 130° C. to 165° C., between about 130° C. to 160° C., between about 130° C. to 155° C., between about 130° C. to 150° C., between about 130° C. to 145° C., between about 130° C. to 140° C., between about 130° C. to 135° C., between about 140° C. to 250° C., between about 140° C. to 245° C., between about 140° C. to 240° C., between about 140° C. to 235° C., between about 140° C. to 230° C., between about 140° C. to 225° C., between about 140° C. to 220° C., between about 140° C. to 215° C., between about 140° C. to 210° C., between about 140° C. to 205° C., between about 140° C. to 200° C., between about 140° C. to 195° C., between about 140° C. to 185° C., between about 140° C. to 180° C., between about 140° C. to 175° C., between about 140° C. to 165° C., between about 140° C. to 160° C., between about 140° C. to 155° C., between about 140° C. to 150° C., between about 140° C. to 145° C., between about 150° C. to 250° C., between about 150° C. to 245° C., between about 150° C. to 240° C., between about 150° C. to 235° C., between about 150° C. to 230° C., between about 150° C. to 225° C., between about 150° C. to 220° C., between about 150° C. to 215° C., between about 150° C. to 210° C., between about 150° C. to 205° C., between about 150° C. to 200° C., between about 150° C. to 195° C., between about 150° C. to 185° C., between about 150° C. to 180° C., between about 150° C. to 175° C., between about 150° C. to 165° C., between about 150° C. to 160° C., between about 150° C. to 155° C., between about 160° C. to 250° C., between about 160° C. to 245° C., between about 160° C. to 240° C., between about 160° C. to 235° C., between about 160° C. to 230° C., between about 160° C. to 225° C., between about 160° C. to 220° C., between about 160° C. to 215° C., between about 160° C. to 210° C., between about 160° C. to 205° C., between about 160° C. to 200° C., between about 160° C. to 195° C., between about 160° C. to 185° C., between about 160° C. to 180° C., between about 160° C. to 175° C., between about 160° C. to 165° C., between about 170° C. to 250° C., between about 170° C. to 245° C., between about 170° C. to 240° C., between about 170° C. to 235° C., between about 170° C. to 230° C., between about 170° C. to 225° C., between about 170° C. to 220° C., between about 170° C. to 215° C., between about 170° C. to 210° C., between about 170° C. to 205° C., between about 170° C. to 200° C., between about 170° C. to 195° C., between about 170° C. to 185° C., between about 180° C. to 250° C., between about 180° C. to 245° C., between about 180° C. to 240° C., between about 180° C. to 235° C., between about 180° C. to 230° C., between about 180° C. to 225° C., between about 180° C. to 220° C., between about 180° C. to 215° C., between about 180° C. to 210° C., between about 180° C. to 205° C., between about 180° C. to 200° C., between about 180° C. to 195° C., between about 180° C. to 185° C., between about 190° C. to 250° C., between about 190° C. to 245° C., between about 190° C. to 240° C., between about 190° C. to 235° C., between about 190° C. to 230° C., between about 190° C. to 225° C., between about 190° C. to 220° C., between about 190° C. to 215° C., between about 190° C. to 210° C., between about 190° C. to 205° C., between about 190° C. to 200° C., between about 190° C. to 195° C., between about 200° C. to 250° C., between about 200° C. to 245° C., between about 200° C. to 240° C., between about 200° C. to 235° C., between about 200° C. to 230° C., between about 200° C. to 225° C., between about 200° C. to 220° C., between about 200° C. to 215° C., between about 200° C. to 210° C., between about 200° C. to 205° C., between about 210° C. to 250° C., between about 210° C. to 245° C., between about 210° C. to 240° C., between about 210° C. to 235° C., between about 210° C. to 230° C., between about 210° C. to 225° C., between about 210° C. to 220° C., between about 210° C. to 215° C., between about 220° C. to 250° C., between about 220° C. to 245° C., between about 220° C. to 240° C., between about 220° C. to 235° C., between about 220° C. to 230° C., between about 220° C. to 225° C., between about 230° C. to 250° C., between about 230° C. to 245° C., between about 230° C. to 240° C., and between about 230° C. to 235° C.

According to some embodiments, the starch moisture content of the RS material or uncooked food product is between about 0% to 50% w/w, which includes between about 0% to about 50% w/w, between about 0% to about 45% w/w, between about 0% to about 40% w/w, between about 0% to about 38% w/w, between about 0% to about 36% w/w, between about 0% to about 35% w/w, between about 0% to about 34% w/w, between about 0% to about 32% w/w, between about 0% to about 30% w/w, between about 0% to about 28% w/w, between about 0% to about 26% w/w, between about 0% to about 25% w/w, between about 0% to about 24% w/w, between about 0% to about 22% w/w, between about 0% to about 20% w/w, between about 0% to about 18% w/w, between about 0% to about 16% w/w, between about 0% to about 15% w/w, between about 0% to about 14% w/w, between about 0% to about 12% w/w, between about 0% to about 10% w/w, between about 0% to about 8% w/w, between about 0% to about 6% w/w, between about 0% to about 5% w/w, between about 0% to about 4% w/w, between about 0% to about 2% w/w, between about 0% to about 1% w/w, between about 0.5% to about 50% w/w, between about 0.5% to about 45% w/w, between about 0.5% to about 40% w/w, between about 0.5% to about 38% w/w, between about 0.5% to about 36% w/w, between about 0.5% to about 35% w/w, between about 0.5% to about 34% w/w, between about 0.5% to about 32% w/w, between about 0.5% to about 30% w/w, between about 0.5% to about 28% w/w, between about 0.5% to about 26% w/w, between about 0.5% to about 25% w/w, between about 0.5% to about 24% w/w, between about 0.5% to about 22% w/w, between about 0.5% to about 20% w/w, between about 0.5% to about 18% w/w, between about 0.5% to about 16% w/w, between about 0.5% to about 15% w/w, between about 0.5% to about 14% w/w, between about 0.5% to about 12% w/w, between about 0.5% to about 10% w/w, between about 0.5% to about 8% w/w, between about 0.5% to about 6% w/w, between about 0.5% to about 5% w/w, between about 0.5% to about 4% w/w, between about 0.5% to about 2% w/w, between about 0.5% to about 1% w/w, between about 1% to about 50% w/w, between about 1% to about 45% w/w, between about 1% to about 40% w/w, between about 1% to about 38% w/w, between about 1% to about 36% w/w, between about 1% to about 35% w/w, between about 1% to about 34% w/w, between about 1% to about 32% w/w, between about 1% to about 30% w/w, between about 1% to about 28% w/w, between about 1% to about 26% w/w, between about 1% to about 25% w/w, between about 1% to about 24% w/w, between about 1% to about 22% w/w, between about 1% to about 20% w/w, between about 1% to about 18% w/w, between about 1% to about 16% w/w, between about 1% to about 15% w/w, between about 1% to about 14% w/w, between about 1% to about 12% w/w, between about 1% to about 10% w/w, between about 1% to about 8% w/w, between about 1% to about 6% w/w, between about 1% to about 5% w/w, between about 1% to about 4% w/w, between about 1% to about 2% w/w, between about 5% to about 50% w/w, between about 5% to about 45% w/w, between about 5% to about 40% w/w, between about 5% to about 38% w/w, between about 5% to about 36% w/w, between about 5% to about 35% w/w, between about 5% to about 34% w/w, between about 5% to about 32% w/w, between about 5% to about 30% w/w, between about 5% to about 28% w/w, between about 5% to about 26% w/w, between about 5% to about 25% w/w, between about 5% to about 24% w/w, between about 5% to about 22% w/w, between about 5% to about 20% w/w, between about 5% to about 18% w/w, between about 5% to about 16% w/w, between about 5% to about 15% w/w, between about 5% to about 14% w/w, between about 5% to about 12% w/w, between about 5% to about 10% w/w, between about 5% to about 8% w/w, between about 5% to about 6% w/w, between about 10% to about 50% w/w, between about 10% to about 45% w/w, between about 10% to about 40% w/w, between about 10% to about 38% w/w, between about 10% to about 36% w/w, between about 10% to about 35% w/w, between about 10% to about 34% w/w, between about 10% to about 32% w/w, between about 10% to about 30% w/w, between about 10% to about 28% w/w, between about 10% to about 26% w/w, between about 10% to about 25% w/w, between about 10% to about 24% w/w, between about 10% to about 22% w/w, between about 10% to about 20% w/w, between about 10% to about 18% w/w, between about 10% to about 16% w/w, between about 10% to about 15% w/w, between about 10% to about 14% w/w, between about 10% to about 12% w/w, between about 15% to about 50% w/w, between about 15% to about 45% w/w, between about 15% to about 40% w/w, between about 15% to about 38% w/w, between about 15% to about 36% w/w, between about 15% to about 35% w/w, between about 15% to about 34% w/w, between about 15% to about 32% w/w, between about 15% to about 30% w/w, between about 15% to about 28% w/w, between about 15% to about 26% w/w, between about 15% to about 25% w/w, between about 15% to about 24% w/w, between about 15% to about 22% w/w, between about 15% to about 20% w/w, between about 15% to about 18% w/w, between about 15% to about 16% w/w, between about 20% to about 50% w/w, between about 20% to about 45% w/w, between about 20% to about 40% w/w, between about 20% to about 38% w/w, between about 20% to about 36% w/w, between about 20% to about 35% w/w, between about 20% to about 34% w/w, between about 20% to about 32% w/w, between about 20% to about 30% w/w, between about 20% to about 28% w/w, between about 20% to about 26% w/w, between about 20% to about 25% w/w, between about 20% to about 24% w/w, between about 20% to about 22% w/w, between about 25% to about 50% w/w, between about 25% to about 45% w/w, between about 25% to about 40% w/w, between about 25% to about 38% w/w, between about 25% to about 36% w/w, between about 25% to about 35% w/w, between about 25% to about 34% w/w, between about 25% to about 32% w/w, between about 25% to about 30% w/w, between about 25% to about 28% w/w, between about 25% to about 26% w/w, between about 28% to about 50% w/w, between about 28% to about 45% w/w, between about 28% to about 40% w/w, between about 28% to about 38% w/w, between about 28% to about 36% w/w, between about 28% to about 35% w/w, between about 28% to about 34% w/w, between about 28% to about 32% w/w, between about 28% to about 30% w/w, between about 30% to about 50% w/w, between about 30% to about 45% w/w, between about 30% to about 40% w/w, between about 30% to about 38% w/w, between about 30% to about 36% w/w, between about 30% to about 35% w/w, between about 30% to about 34% w/w, between about 32% to about 50% w/w, between about 32% to about 45% w/w, between about 32% to about 40% w/w, between about 32% to about 38% w/w, between about 32% to about 36% w/w, between about 32% to about 35% w/w, and between about 32% to about 34% w/w.

According to some embodiments, the RS material or uncooked food product may be exposed to the low-moisture treatment for a period of 1 minute to 4 hours, which includes between about 0.1 hour to 1 hour, between about 0.2 hour to 1 hour, between about 0.3 hour to 1 hour, between about 0.4 hour to 1 hour, between about 0.5 hour to 1 hour, between about 0.6 hour to 1 hour, between about 0.7 hour to 1 hour, between about 0.8 hour to 1 hour, between about 0.9 hour to 1 hour, between about 0.1 hour to 4 hours, between about 0.2 hour to 4 hours, between about 0.3 hour to 4 hours, between about 0.4 hour to 4 hours, between about 0.5 hour to 4 hours, between about 0.6 hour to 4 hours, between about 0.7 hour to 4 hours, between about 0.8 hour to 4 hours, between about 0.9 hour to 4 hours, between about 1 hour to 4 hours, between about 1.1 hours to 4 hours, between about 1.2 hours to 4 hours, between about 1.3 hours to 4 hours, between about 1.4 hours to 4 hours, between about 1.5 hours to 4 hours, between about 1.6 hours to 4 hours, between about 1.7 hours to 4 hours, between about 1.8 hours to 4 hours, between about 1.9 hours to 4 hours, between about 2.0 hours to 4 hours, between about 2.1 hours to 4 hours, between about 2.2 hours to 4 hours, between about 2.3 hours to 4 hours, between about 2.4 hours to 4 hours, between about 2.5 hours to 4 hours, between about 2.6 hours to 4 hours, between about 2.7 hours to 4 hours, between about 2.8 hours to 4 hours, between about 2.9 hours to 4 hours, between about 3.0 hours to 4 hours, between about 3.1 hours to 4 hours, between about 3.2 hours to 4 hours, between about 3.3 hours to 4 hours, between about 3.4 hours to 4 hours, between about 3.5 hours to 4 hours, between about 3.6 hours to 4 hours, between about 3.7 hours to 4 hours, between about 3.8 hours to 4 hours, and between about 3.9 hours to 4 hours.

According to some embodiments, heated low-moisture food products are provided that possess a significant RS content and moderated glycemic response. The heated food products of the present invention may comprise RS starch material (e.g., corn starch, amylose starch, potato starch), RS potato granules, potato flakes, and/or potato flours for the purposes of preparing snack foods, breads, crackers, etc. The food products of the present embodiments comprise starch in its native or resistant state. Accordingly, the food products of the present embodiments comprise greater than 5% of its starch in the native or ungelatinized (semi-crystalline) state. This includes from about 5% to about 100%, from about 5% to about 99%, from about 5% to about 98%, from about 5% to about 95%, from about 5% to about 90%, from about 5% to about 85%, from about 5% to about 80%, from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 25%, from about 5% to about 20%, about 30% to about 100%, from about 30% to about 99%, from about 30% to about 98%, from about 30% to about 95%, from about 30% to about 90%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 30% to about 45%, from about 30% to about 40%, from about 30% to about 35%, from about 40% to about 100%, from about 40% to about 99%, from about 40% to about 98%, from about 40% to about 95%, from about 40% to about 90%, from about 40% to about 85%, from about 40% to about 80%, from about 40% to about 75%, from about 40% to about 70%, from about 40% to about 65%, from about 40% to about 60%, from about 40% to about 55%, from about 40% to about 50%, from about 40% to about 45%, from about 50% to about 100%, from about 50% to about 99%, from about 50% to about 98%, from about 50% to about 95%, from about 50% to about 90%, from about 50% to about 85%, from about 50% to about 80%, from about 50% to about 75%, from about 50% to about 70%, from about 50% to about 65%, from about 50% to about 60%, from about 50% to about 55%, from about 60% to about 100%, from about 60% to about 99%, from about 60% to about 98%, from about 60% to about 95%, from about 60% to about 90%, from about 60% to about 85%, from about 60% to about 80%, from about 60% to about 75%, from about 60% to about 70%, from about 60% to about 65%, from about 70% to about 100%, from about 70% to about 99%, from about 70% to about 98%, from about 70% to about 95%, from about 70% to about 90%, from about 70% to about 85%, from about 70% to about 80%, from about 70% to about 75%, from about 80% to about 100%, from about 80% to about 99%, from about 80% to about 98%, from about 80% to about 95%, from about 80% to about 90%, from about 80% to about 85%, from about 90% to about 100%, from about 90% to about 99%, from about 90% to about 98%, and from about 90% to about 95%.

### DEFINITIONS

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only not intended to be limiting. Other features and advantages of the invention will be apparent from the following detailed description and claims.

Reference to numeric ranges throughout this specification encompasses all numbers falling within the disclosed ranges. Thus, for example, the recitation of the range of about 1% to about 5% includes 1%, 2%, 3%, 4%, and 5%, as well as, for example, 2.3%, 3.9%, 4.5%, etc.

For the purposes of promoting an understanding of the embodiments described herein, reference will be made to preferred embodiments and specific language will be used to describe the same. The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a composition” includes a plurality of such compositions, as well as a single composition, and a reference to “a therapeutic agent” is a reference to one or more therapeutic and/or pharmaceutical agents and equivalents thereof known to those skilled in the art, and so forth.

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

### EXAMPLES

It is understood that modifications which do not substantially affect the activity of the various embodiments of this invention are also provided within the definition of the invention provided herein. Accordingly, the disclosed examples are intended to illustrate but not limit the present invention. While the claimed invention has been described in detail and with reference to specific embodiments thereof, it will be apparent to one of ordinary skill in the art that various changes and modifications can be made to the claimed invention without departing from the spirit and scope thereof. Thus, for example, those skilled in the art will recognize, or be able to ascertain, using no more than routine experimentation, numerous equivalents to the specific substances and procedures described herein. Such equivalents are considered to be within the scope of this invention, and are covered by the following claims.

### Example 1

To investigate modification with actual commercial food-grade reagents, commercial potato granules were substituted with propylene oxide (PO) using a factorial experimental design consisting of four PO addition levels (4.6%, 9.1%, 12.8% and 18.3% [w/w], based on potato granule dry weight) and two reaction temperatures (22 and 48° C.). Molar substitution (MS) values increased with both increasing PO addition levels and reaction temperatures. Enhancement of PO MS levels with increasing reaction temperature was attributed to a combination of possible factors including increased swelling of starch, a possible reduction of the Donnan potential, and/or a greater proportion of deprotonated starch alkoxide ions available for reaction. A positive correlation (r=0.93) between PO MS and RS levels indicated that incorporation of bulky hydroxypropyl groups onto starch molecules resulted in steric hindrance to the enzymic digestion, effectively promoting RS formation.

In contrast to RS, only low levels of slowly digestible starch (SDS) were achieved with potato granule chemical modification.

### Example 2

In a second factorial experiment, the combined effects of PO substitution (0%, 10%, and 20% [w/w], based on potato granule dry weight), cross-linking with sodium trimetaphosphate (STMP) (0%, 1%, 2%, and 4% [w/w], based on potato granule dry weight), and reaction temperature (22, 34 and 48° C.) were investigated in regard to degrees of derivatization and RS formation. Both PO and STMP significantly contributed to RS formation, though the combined effects of two reagents were simply additive, rather than synergistic. The estimated Glycemic Index (eGI) for dual modified potato granules was significantly decreased by derivation (from 116.4 for unmodified granules to 59.7-65.9 for dual-modified granules), affecting both the rate and extent of starch hydrolysis by amylolytic enzymes. From a practical standpoint, the higher allowable reagent addition levels make PO a better choice than STMP for enhancement of RS content and reduction of the glycemic response within commercial potato granules.

As viewed by scanning electron microscopy (SEM), modified potato granules retained an intact parenchyma cell structure, but did exhibit a slightly shrunken appearance compared to commercial potato granules. In regard to proximate composition, modified potato granules exhibited both decreased protein and lipid contents 50% reductions), as well as slightly increased total carbohydrate, starch and ash contents, relative to commercial (unmodified) potato granules. Hydroxypropylation was observed to enhance the retrogradation stability of starch within modified potato granules relative to that within the commercial control. Thus, PO substitution has potential to improve the physical properties of potato granules for use in refrigerated and/or frozen foods systems.

In short, it was possible to enhance the RS content and decrease the eGI of commercial potato granules through chemical modification with PO and STMP reagents, achieving RS contents as high as 50% (i.e. potato granules with improved RS/glycemic characteristics).

### Materials And Methods

Commercial Potato Granule and Starch Sources: Commercial potato granules provided by Basic American Foods (Blackfoot, Id.) were the primary substrate in all modification experiments. Native potato starch was obtained from AVEBE (Veendam, Netherlands) as a reference material for resistant starch assays.

Chemical Modification of Commercial Potato Granules with Propylene Oxide

Commercial potato granules were modified with propylene oxide at four different reagent addition levels (4.6%, 9.1%, 12.8%, and 18.3% [w/w], based on potato granule dry weight) under two different temperature conditions (22° C. and 48° C.) to determine the effect of chemical modification on RS formation. Reaction system parameters for the factorial (4×2) experiment are provided in Table 2.

TABLE 2
Reaction System Parameters¹ for Substitution of
Commercial Potato Granules with Propylene Oxide

| Reagent Ad- | Isopropa- | 5.0M NaOH | Potato Granules | Propylene |
|---|---|---|---|---|
| dition Level | nol (mL) | (mL) | (g, dry weight) | Oxide (mL)² |
| Control | 10.5 | 3.5 | 4.5 | 0.00 |
| PO-1 | 10.5 | 3.5 | 4.5 | 0.25 |
| PO-2 | 10.5 | 3.5 | 4.5 | 0.50 |
| PO-3 | 10.5 | 3.5 | 4.5 | 0.75 |
| PO-4 | 10.5 | 3.5 | 4.5 | 1.00 |

Dual Chemical Modification of Commercial Potato Granules with Propylene Oxide and Sodium Trimetaphosphate (STMP)

Potato granules were modified with both propylene oxide and sodium trimetaphosphate (STMP) to investigate the effects of dual chemical modification on RS formation. A factorial design (3×4×3) utilizing three propylene oxide addition levels (0%, 10%, and 20% [w/w], based on potato granule dry weight), four levels of STMP addition (0%, 1.0%, 2.0%, and 4.0% [w/w], based on potato granule dry weight), and three reaction temperature conditions (22° C., 34° C., and 48° C.) was used for modification of potato granules.

### Molar Substitution (MS) Determination for Hydroxypropylated Potato Granules

Molar substitution (MS) values of modified potato granules were determined by the spectrophotometric procedure of Johnson (1969). The weight percent ratio (%) of hydroxypropyl groups per unit weight of potato granule sample was calculated according to equation (1) below:

Hydroxypropyl group content(C₃H₇O %)=(C×0.7763×10)/W (1)

where C equals the concentration of propylene glycol equivalent groups present in the analyzed sample solution (g/mL, obtained from the standard curve). The coefficient of 0.7763 was used for conversion of the weight of a propylene glycol molecule to that of a hydroxypropyl group (HPG), while W represents the weight of the starch portion of the potato granule sample (mg) being analyzed. A net factor of 10 was included to collectively account for unit conversion [μg to mg], dilution factors, and percent ratio calculations. For simplicity (and as a conservative approach to calculating MS levels within the starch fraction), this calculation presumes all reagent groups to be located within the starch fraction. Using the value obtained from equation (1), starch MS values (average number of hydroxypropyl groups per anhydroglucose unit [AGU]) were obtained using equation (2),

MS=(C₃H₇O %×162)/((100×C₃H₇O %)×59.08) (2)

where the numbers 162 and 59.08 reflect the molecular weights of an AGU and a hydroxypropyl group, respectively (Lawal et al., 2008).

### Degree of Substitution (DS) Determination for Cross-linked Potato Granules

Incorporated phosphorus was calculated by subtracting the indigenous phosphorus content (0.0032 g/g potato granule) of the reaction control from the total phosphate content of the modified potato granules. Phosphorus (P) levels in modified potato granules were determined by inductively coupled plasma-atomic emission spectroscopy (ICP-AES) according to the method of Anderson (1996). Similar to the MS calculation for hydroxypropylation, DS values were calculated under the presumption that incorporated phosphorus was located solely within the starch fraction of potato granules. The formula for calculating the degree of substitution (DS) of potato starch derivatized with STMP is outlined in equation (3):

DS=P*162/31 (3)

In this equation, 162 represents the molecular weight of a starch AGU, 31 represents the molecular weight of phosphorus, and P reflects the weight equivalent of incorporated phosphorus (g/g starch) within modified potato granules.

### In Vitro Determination of Starch Digestibility

In vitro hydrolysis of both modified and control and potato granules were analyzed according to the method described by Englyst et al. (1992) with minor modification.

Briefly, the various starch fractions (total starch [TS]; rapidly digestible starch [RDS]; slowly digestible starch [SDS]; resistant starch [RS]) were calculated based on the amounts of glucose (rapidly available glucose [RAG] or slowly available glucose [SAG]) released from potato granule or starch samples during incubation with invertase, pancreatin and amyloglucosidase. In general, incubation of starch-containing materials was conducted at 37° C. in capped tubes immersed within a shaking water batch. Though determination of the various starch fractions is described below on the basis of a single sample, in reality, it was possible to simultaneously analyze up to seven sample tubes at a time (including a reaction control and sample blank).

Enzyme Solution and Reagent Preparation

Enzyme solutions for the various analyses were prepared as follows. Amyloglucosidase solution was prepared by transferring 0.24 mL of enzyme (300 units/mL, Catalog No. A7095, Sigma-Aldrich Corp.) to a 5 mL glass beaker, which was diluted to 0.5 mL with deionized water, resulting in a final enzyme concentration of 140 units/mL. Pancreatin enzyme solution was prepared by diluting pancreatin (1.0 g, Catalog No. 7545, Sigma-Aldrich Corp.) in deionized water (6.7 mL) within a 50 mL polypropylene centrifuge tube. The solution was stirred (5 min) and centrifuged (1500×g, 10 min), after which the supernatant was retained. A portion of the resulting pancreatin solution supernatant (4.5 mL) was mixed with prepared amyloglucosidase solution (0.5 mL) and 0.5 mg of invertase (300 units/mg, Catalog No. 14504, Sigma-Aldrich Corp.) to produce the final enzyme solution used for all analyses. All enzyme solutions were prepared fresh just prior to use.

For preparing the buffer, 13.6 g of sodium acetate trihydrate was dissolved in saturated benzoic acid solution (250 mL), and diluted to 1.0 L with deionized water. Acetic acid (0.1 M) was used to adjust the buffer solution to pH 5.2, after which 1.0 M CaCl₂ solution (4 mL) was added to stabilize and activate the enzymes.

### In Vitro Measurement of Rapidly Available Glucose (RAG) and Slowly Available Glucose (SAG)

Modified potato granule material or starch (600 mg db) was weighed into a 50 mL polypropylene centrifuge screw-cap tube, followed by addition of 0.1 M sodium acetate buffer solution (20 mL). A sample blank containing only acetate buffer (no potato granule or starch material) was prepared to correct for any glucose present in the amyloglucosidase solution. The tube containing potato granule or starch material was capped and vortexed vigorously (1 min).

For potato granule or starch samples to be analyzed “as eaten” (following a cooking step), the tube was placed in a boiling water bath for 30 min, after which it was cooled to ambient temperature. For potato granule or starch samples analyzed on an “as is” basis, this heating step was omitted.

The tube containing potato granule or starch material was equilibrated to 37° C. in a shaking water bath (Model 406015, American Optical, Buffalo, N.Y.). After reaching the target temperature, 5 mL of the final enzyme solution was added to the potato granule or starch suspension. The tube was then tightly capped and firmly secured to the shaking mechanism of the water bath in a horizontal manner (fully immersed), and the water bath was adjusted to 160 strokes per min. In addition, two additional tubes containing 66% (v/v) aqueous ethanol (20 mL) were prepared, and set aside for extraction of glucose from potato granule or starch samples subjected to enzyme digestion after 20 and 120 min, respectively.

After 20 min of incubation, 0.5 mL of the resulting hydrolyzate was removed from the original 25 mL suspension (dilution factor [D]=50 in equation (4)) and transferred to a previously prepared tube containing 66% aqueous ethanol (20 mL; test volume [Vt]=20.5 in equation (4)), representing the amount of glucose released from samples after 20 min of digestion (RAG; tube was designated G20). After sampling, the original tube containing potato granule or starch material was immediately returned to the shaking water bath for further incubation. After an additional 100 min of incubation (total of 120 min), a second 0.5 mL sample was again removed and transferred to a second tube containing 66% aqueous ethanol (representing the amount of glucose released from samples after 120 min of digestion [SAG]; tube was designated G120). The G20 and G120 tubes were both centrifuged (1500×g, 5 min) to yield clear supernatants (containing glucose) prior to further glucose analysis as described in the subsequent paragraph.

For generated supernatants (G20, G120) representing modified potato granules, 0.1 mL of each supernatant was pipetted into separate cuvettes. Glucose content was measured using a commercially available kit via the glucose oxidase/peroxidase enzymic reactions (Glucose Assay Kit [K-GLUC], Megazyme International Ireland Ltd., Wicklow, Ireland). Glucose oxidase/peroxidase reagent (GOPOD) and acetate buffer blank were prepared as directed by the kit manufacturer. GOPOD reagent (3.0 mL) was added to each cuvette (containing 0.1 mL of G20 or G120 solution), after which cuvettes were subsequently incubated at 45° C. (20 min). A tube containing 0.1 mL of glucose standard solution (1.0 mg/mL; designated AD-glucose standard in equation (4)) was treated in the same manner. Following incubation, cuvettes were analyzed on a spectrophotometer at 510 nm against an acetate buffer blank. Absorbance values of the experimental sample _{(ASample)} and the known glucose standard (AD-glucose standard) were measured. Glucose content (%) was calculated according to equation (4) below:

Glucose=100*[1.0 (mg/mL)*ASample/AD-glucose standard]*Vt*D/Wt (4)

Glucose detected in G20 supernatant was designated as G′20 and glucose detected in G120 samples was designated as G′120. Wt represents the total weight of potato granules or starch (mg). As noted earlier in this section, Vt represents the total volume of test solution (20.5 mL) and D represents the dilution factor (50). A factor of 100 was included to account for conversion of the unit ratio of glucose (mg/mg potato granules) to a percent ratio (%) of the potato granule weight.

### Measurement of Total Glucose (TG) Content (Unmodified Reaction Control Potato Granules)

For determination of the total digestible glucose (TG) content within reaction control potato granule samples (and to estimate this value within modified potato granules), reaction control potato granule material was prepared/heated and subjected to enzymatic digestion similar to the protocol described above. However, the tube containing the potato granule reaction control material was digested only for 120 min (i.e., included no 20 min incubation period). After 120 min incubation, the tube containing the original 25 mL digestion volume was placed in a boiling water bath (30 min), vortexed (10 sec), and cooled in an ice water bath (20 min). Following cooling, 7.0 M KOH (10 mL) was transferred to the tube with mixing, and the tube was shaken in an ice water bath (30 min) at 120 stokes per minute. Resulting hydrolyzate (1 mL) was transferred to a 50 mL centrifuge tube containing 0.5 M acetic acid (10 mL) (dilution factor [D]=35 in equation (4)). Prepared amyloglucosidase solution (0.2 mL) was added to the tube, which was then incubated at 70° C. in a water bath (30 min). Following incubation, the tube was transferred to a boiling water bath (10 min), cooled to room temperature, and diluted to 50 mL with deionized water (50 mL; test volume [Vt]=50 in equation 4). The tube was then centrifuged (1500×g, 5 min) to remove any remaining insoluble material. Supernatant (0.1 mL) was pipetted into a cuvette along with GOPOD reagent (3 mL), and the total glucose content was determined as described above to provide a measure of the total glucose (i.e., starch) present in the potato granule reaction control material. Glucose content (TG) was calculated with equation (4) using the values Vt (50) and D (35).

### Determination of Resistant, Slowly Digestible, Rapidly Digestible, and Total Starch

RDS (rapidly digestible starch), SDS (slowly digestible starch), RS (resistant starch), and TS (total starch) were determined from G′20, G′120, and TG values using equations 5-8 below. A factor of 0.9 in these equations was used to convert glucose values to starch contents.

RDS=G′20×0.9. (5)

SDS=(G′120−G′20)×0.9. (6)

TS=TG×0.9. (7)

RS=TS −(RDS+SDS) (8)

### In Vitro Starch Digestibility Index and Estimated Glycemic Index Determinations

The digestibility index of unmodified or modified potato granules was measured similar to the method described for determination of RAG and SAG. For this determination, potato granule hydrolyzate was prepared and incubated as previously outlined, but sampled at 30 min intervals over a total analysis period of 150 min, yielding G30, G60, G90, G120, G150 hydrolyzate solutions (corresponding to the hydrolzate collected for each respective digestion time). For each digestion time, hydrolyzate was centrifuged (1500×g, 5 min) to yield clear supernatant (containing glucose), which was assayed for glucose content via the glucose oxidase/peroxidase procedure described herein. Glucose released during the various digestion periods (designated as G′30, G′60, G′90, G′120, and G′150) was calculated using equation (4). The procedure of Goni et al. (1997) was used to measure the starch digestibility index, which is calculated by dividing the amount of starch digested after 90 min of incubation (HI90) by the total starch content of the reaction control, according to equation (9). The estimated glycemic index (eGI) was calculated according to equation (10) (Goni. et al., 1997).

HI90=((G′90×0.9)/TS)×100 (9)

eGI=39.21+0.803*(HI90) (10)

### Results and Discussion

### Validation of Resistant/Slowly Digestible Starch Determination Methods

Of the various in-vitro RS determination methods, the AOAC dietary fiber determination (Method 985.29; AOAC, 1997) and the Englyst et al. (1992) procedures have been widely acknowledged for their good repeatability and reliability. The Englyst et al. (1992) in vitro method has also been designed and validated to simulate the human digestive process using a combination of enzymes (invertase, pancreatic-amylase and amyloglucosidase). In this study, commercial potato granules (‘as is’ and hydrated/heated) and potato starch (native/raw and hydrated/heated) were evaluated according to the method of Englyst et al. (1992) to verify proper determination of resistant starch (RS), slowly digestible starch (SDS), and rapidly digestible starch (RDS) values (Table 4). Of all samples evaluated, native/raw potato starch possessed the highest proportion of RS (78.1 g/100 g dry matter or 78.1%), which was in good agreement with other in vitro-derived values reported by Gormley and Walshe (1999) (74.4%), Champ et al. (1999) (77.7%), and McCleary and Monaghan (2002) (77.0%). Our value also compared favorably to the in vivo RS value (78.8%) determined for raw potato starch by Champ et al. (2003). In contrast, hydrated/heated (gelatinized) potato starch exhibited only low levels of RS (1.8%), due to loss of the native starch granule structure upon heating. For commercial potato granules (‘as is’), low levels of RS were observed (5.7%), though these initial values were reduced to negligible levels by simple heating (hydrated/heated, 0.3%). Overall, these results were reasonably consistent with those published by Susan and Englyst (1993), who reported a RS value of 1% for commercial instant potato granules (‘as is’) based on an in vitro method. The slight variance between reports might not only originate from differing experimental conditions, but also from varying processing conditions employed by potato granule manufacturers that could induce differing degrees of starch retrogradation within potato cells. In regard to SDS, native/raw potato starch exhibited a value of 16.6%, which was in very close approximation to that obtained by Englyst et al. (1992) (16.0%) using the same method applied in our study. In contrast, after heating, the SDS value for hydrated/heated potato starch decreased markedly (from 16.6% to 1.0%), while both ‘as is’ and hydrated/heated instant potato granules contained very similar, but relatively low, SDS levels (2.3% and 2.5% respectively), neither of which appeared to be influenced by heating/boiling.

TABLE 4
Mean Values^{1,2} of Total Starch (TS), Rapidly Digestible Starch (RDS), Slowly Digestible
Starch (SDS), and Resistant Starch (RS) for Commercial Potato Granules and Potato Starch

| Samples | TS | RDS | SDS | RS |
|---|---|---|---|---|
| Potato Granules (‘as is’) | 78.9 ^{a} ± 3.5 | 70.9 ^{b} ± 2.1 | 2.3 ^{a} ± 0.8 | 5.7 ^{b} ± 1.0 |
| Potato Granules (rehydrated/heated) | 78.8 ^{a} ± 3.8 | 76.0 ^{c} ± 1.9 | 2.5 ^{a} ± 1.2 | 0.3 ^{a} ± 0.4 |
| Potato Starch (raw/native) | 99.6 ^{b} ± 2.8 | 4.9 ^{a} ± 1.6 | 16.6 ^{b} ± 2.8 | 78.1 ^{c} ± 1.6 |
| Potato Starch (rehydrated/heated) | 101.5 ^{b} ± 3.0 | 98.7 ^{d} ± 0.2 | 1.0 ^{a} ± 0.4 | 1.8 ^{a} ± 0.5 |

¹Mean values ± standard deviations determined from duplicate measurements. Values within a column sharing a common letter are not significantly different (p < 0.05).
²g/100 g dry matter (Englyst et al. 1992); RS = TS − (RDS + SDS).
¹Reactions were allowed to proceed 24 hours, and were conducted separately for the two different temperature conditions (22° C. and 48° C).
²Reagent addition levels for potato granule reactions (PO-1, PO-2, PO-3, PO-4) translated into 4.6%, 9.1%, 12.8%, and 18.3% (w/w) propylene oxide, respectively, based on potato granule dry weight.

The greatest reduction in both RS and SDS occurred with the initial heating/gelatinization of raw starch, coinciding with the destruction of the native starch granule structure (RS2). Commercial potato granules (‘as is’), which have already been cooked/heated (above the starch gelatinization temperature) during industrial processing, possessed low RS levels that were easily reduced to negligible values upon heating at boiling temperature. Thus, low levels of RS present in commercial potato granules (‘as is’) were likely a result of amylopectin retrogradation incurred during industrial processing, which structures are known to be disrupted by boiling. SDS levels within commercial potato granules (‘as is’ and hydrated/heated) were relatively insignificant, and were not largely affected or reduced by heating at boiling temperature. The experimental RS/SDS values generated in this work appear to be relevant and valid in relation to values reported in the literature.

### Effect of Substitution of Potato Granules on Starch MS, RS, and SDS Levels

The high correlation between RS and MS can be explained by the introduction of bulky hydroxypropyl groups onto starch molecules at the O-2, O-3 or O-6 positions of the starch anhydroglucose unit (AGU). Although there is no doubt that hydroxypropylation increases steric hindrance, the specific position of substitution on the starch AGU remains a subject of debate (Richardson et al., 2000). Most studies have suggested that the hydroxypropyl substituent is most likely to be introduced at the 0-2 position of the starch AGU (Xu and Seib, 1996; Merkus et al., 1977; Richardson et al., 2000). The presence of substituent groups along starch chains increases steric hindrance and decreases starch susceptibility to enzymatic hydrolysis.

Based on digestion with pancreatin, Leegwater (1972) provided a statistical model to define the exponential decrease in reducing power for hydroxypropyl starch with increasing levels of MS. It was explained that for a random distribution of hydroxypropyl groups on starch molecules, reducing power was directly proportional to starch MS.

### Example 3

Previous studies have demonstrated several methods for solubilization and/or disintegration of pectic substances within potato tuber tissue. The primary focus of past studies has been on the characterization of plant tissue components, including determination of cell wall composition, understanding the compositional/structural basis of potato texture, observation of starch gelatinization in cells, and/or elucidation of pectic substances within the cell wall middle lamella.

The focus of the proposed study will be on development of an effective and efficient means for inducing cell separation to yield a dehydrated potato flour product with starch in its ungelatinized or native granular state. In this study, the separation of parenchyma cells from raw potato tissue of Russet Burbank (RB) and Russet Norkotah (RN) cultivars was investigated using both alkaline (ALK) and enzyme (ENZ) treatments. The ALK method involved soaking raw potato tissue in NaOH containing sodium hexametaphosphate (SHMP) as a chelating agent, while the ENZ method utilized polygalacturonase (PG) for degradation of pectic substances within the middle lamella. The ALK and ENZ treatments yielded up to four tissue fractions: 1) isolated parenchyma cells (‘Cell’), 2) free starch (‘Starch’), 3) soluble cell wall polysaccharides (Pectin), and 4) extraneous potato tissue residue remaining after fractionation (Residue). The isolated ‘Cell’ fractions representing each of the four cultivar/isolation method combinations were the principal fractions of interest, and were further characterized in regard to fraction yield, microstructure, chemical composition, and physical properties.

Both cultivar and isolation method significantly affected ‘Cell’ fraction yields. The overall isolation yield of the ‘Cell’ fraction, which possessed ungelatinized starch within the intact cell wall structure, was in the range of 40-60% (w/w, based on the total solids of the raw potatoes used as starting material). ‘Cell’ fraction yields from raw potato tissue for the four cultivar/isolation scheme combinations followed the order: RN ENZ>RB ENZ>RN ALK>RB ALK. RN produced greater ‘Cell’ fraction yields than RB, while the ENZ method was more productive than the ALK method in this regard. Scanning electron microscope (SEM) and light microscope (LM) observations revealed that the ‘Cell’ fractions were comprised of intact parenchyma cells containing ungelatinized starch granules. Light microscope images revealed that the cell walls of the ALK ‘Cell’ fractions appeared to swell or enlarge in the presence of water, while those of the ENZ ‘Cell’ fractions did not appear to swell under the same conditions. Compositional analysis revealed that both cultivars and methods significantly affected ‘Cell’ fraction composition. The isolation method effect influenced ‘Cell’ fraction composition to a greater degree relative to the effects of cultivar. The ENZ method removed more non-starch polysaccharides from the ‘Cell’ fraction than the ALK method. This observation could explain why the ALK ‘Cell’ fraction appeared to swell or enlarge in the presence of water more than those of the ENZ ‘Cell’ fraction.

Thermal analysis of the ‘Cell’ fractions by differential scanning calorimetry (DSC) showed that the starch gelatinization properties within the cells were significantly influenced by the fractionation methods. The ALK method appeared to alter the amorphous regions of the starch granules, leading to slightly decreased gelatinization temperatures. In contrast, the elevated temperatures employed with the ENZ method led to annealing of starch granules within the cells, which process led to a narrowing of the starch gelatinization range.

Pasting analysis of ‘Cell’ fractions showed that the ENZ ‘Cell’ fractions exhibited a greater inhibition of pasting viscosities relative to those of the ALK ‘Cell’ fraction. The RB ‘Cell’ fraction was initially thought to exhibit more inhibited pasting viscosities relative to those of the RN ‘Cell’ fraction. However, the initial differences were shown to be due to an effect of cold-sweetening within the raw potatoes over the course of the four-week period of the experiment, which effect appeared to affect the RN cultivar more than the RB cultivar. The effects from both the cultivar and method on the rheology of the ‘Cell’ fraction were more the function of the cell wall characteristics, even though starch was the major component of the ‘Cell’ fraction.

Materials and Methods

Potato Tuber Sources. Two potato cultivars, Russet Burbank (RB) and Russet Norkotah (RN) were the sources of all potato material used in this study. Potatoes were purchased from a local grocery store in Moscow, Id., and were stored at 5° C. prior to over the course of the four-week experimental period prior to use in the study.

Lyophilized Potato Flour Preparation and Potato Tissue Fractionation. Potato tubers were stored at ambient temperature (25° C.) for 48 hr prior to their use in isolation experiments. Potatoes were washed with deionized water, after which both the stem and bud ends were removed with a knife (1 cm from the ends). Tubers were then hand peeled, and soaked in deionized water to prevent enzymatic browning. Peeled tubers were sliced parallel to their long axis into 1 mm slices using a commercial meat slicer (Hobart, Troy, Ohio). Potato slices were either lyophilized to generate a reference potato flour (control material) or subjected to alkaline and enzyme fractionation methods for parenchyma cell isolation.

Lyophilized Reference Potato Flour Preparation. This method was adapted from Higley et al. (2003). Raw potato slices were weighed, transferred to one-gallon zip-lock bag, and frozen/stored at −80° C. Frozen potato slices were lyophilized using a Labconco Freeze Dryer System/Freeze Zone® 4.5 (Kansas City, Mo.) for 6 days (2-6% final moisture content). Lyophilized potato samples were weighed on a scale, and subsequently ground into flour using a Waring Blender, which was connected to a Powerstat® Variable Autotransformer (operated at 70 volts). For grinding, lyophilized potato material was ground at high speed for 30 sec, and passed through a sieve (U.S. No. 20, 850 μm). Potato material too large to pass through the sieve was ground for an additional 10 sec, and passed though the sieve again. After the additional grinding, any remaining material, which consisted of residue of skin, eyes, stems, and buds, was discarded. The lyophilized, ground potato flours were stored in one-gallon zip-lock bags at −20° C. until further analysis.

Alkaline Treatment (ALK) for Potato Tissue Fractionation. An alkaline treatment (ALK) was adapted from Turquois et al. (1999). Potato slices (50 g) were transferred to a flask (500 ml) containing deionized water (400 ml). The pH of the solution was adjusted to 3.5±0.1 using 1M HCl, and the potato slices were soaked for 1 hr, after which the pH of the solution was neutralized to 6.5-7.0 using 0.1 M NaOH. The potato slices were removed from the soaking solution, allowed to drain, and were resuspended in 0.08 M NaOH (350 ml) containing 0.75% (w/v) sodium hexametaphosphate (SHMP, chelating agent). Potato slices were initially stirred (130 rpm) for 1.5 hr with a 3″ stir bar using a Variomag Tele System Stirring Drive Hp 15 (Variomac-USA, Daytona Beach, Fla.), and subjected to further stirring (700 rpm) over the course of 8.5 hr using 1″ stir bars. All stirring was conducted in a controlled temperature water bath at 25° C. to minimize gelatinization of the starch under basic pH conditions. After 10 hr of total stirring, the majority of the potato tissue had been predominantly reduced to a suspension of small particles of potato tissue, largely consisting of individual parenchyma cells and multi cell aggregates. The pH of the suspension was neutralized to 6.5-7.0 using 6 M HCl, and the neutralized suspension of tissue particles was passed over a series of sieves (U.S. No. 20/850 μm; U.S. No. 140/106 μm); an additional portion of deionized water (50 ml) was needed to aid passage of the material to the sieves. The material that passed though the sieves was collected and set aside, comprising both free starch (referred to as ‘Starch’) and soluble non-starch polysaccharides (NSP) (further purification of these fractions will be discussed later).

The tissue material retained by the two sieves was rinsed with additional deionized water (1000 ml). The material retained by the U.S. No. 140 sieve was collected as isolated potato parenchyma cells and multi cell aggregates, and was referred to as the ‘Cell’ fraction. The tissue material retained by the U.S. No. 20 sieve, which consisted of relatively large pieces (1-5 mm in diameter) of non-separated tissue material, was collected as extraneous potato tissue residue (termed ‘Residue’). The rinse water (1000 ml), that was passed though both sieves, was added to the combined Starch/NSP fraction previously set aside. The ‘Cell’ and ‘Residue’ fractions were resuspended in an excess of deionized water and allowed to sediment (24 hr), after which the excess water was poured off without disrupting the sediment. Acetone was added to yield a 1:1 acetone:water mixture (v/v). Both tissue fractions were collected on a Büchner funnel (Whatman No. 1 filter paper) via vacuum filtration, and allowed to air-dry at ambient temperature (25° C.) to a constant weight (≈48 hr) before weighing. Collected tissue fractions were stored in sample bottles at ambient temperature until further analysis.

For recovery of ‘Starch’ and soluble NSP, the combined ‘Starch’ and soluble NSP suspension that had been previously set aside was centrifuged (2500×g) for 20 min. The supernatant was retained for the soluble NSP fraction, while ‘Starch’ fraction was retained in the pellet.

The starch pellet was brought up in 1:1 acetone:water (v/v), collected on a Büchner funnel (Whatman No. 1 filter paper) via vacuum filtration, and allowed to air-dry at ambient temperature (25° C.) to a constant weight (≈48 hr) before weighing. This material represented the purified ‘Starch’ fraction.

Non-starch polysaccharides (predominantly pectin) were precipitated from the supernatant solution by adjusting the pH to 2.0 with 6 N HCl, after which the suspension was stirred for 10 min and held at 5° C. for 24 hr. Precipitated material was collected by centrifugation (3500×g, 20 min), and the supernatant was discarded. The precipitate was resuspended in deionized water (5 parts water to 1 part precipitate by volume), and neutralized with 32% (w/v) NaOH (pH 6.5-7.0). The material was re-precipitated by adding absolute ethanol to yield a final ethanol concentration of 50% (v/v), after which the suspension was stirred for 10 min and held at 5° C. for 1 hr. Non-starch polysaccharides were recovered by centrifugation (3500×g, 20 min), and the pallet was washed exhaustively with absolute ethanol on a Büchner funnel (Whatman No. 1 filter paper) via vacuum filtration. Lastly, the recovered material was allowed to dry at ambient temperature (25° C.) to a constant weight (≈48 hr), and stored at ambient temperature (25° C.) within sample bottles. This NSP material, which was anticipated to be predominantly pectin, was referred to as the ‘Pectin’ fraction for the simplicity of discussion

Enzyme Treatment (ENZ) for Potato Tissue Fractionation. Potato slices (50 g) were added to a flask (500 ml) containing citrate buffer solution (350 ml, pH 4.10±0.05). Citrate buffer was prepared using 0.1 M citric acid solution and 0.1 M sodium citrate solution at a volume ration of 33.0:17.0 ml, respectively. The mixture was diluted to 100 ml with deionized water, and pH was adjusted to 4.10±0.05 using 0.1 M NaOH and/or 1.0 M HCl (Ruzin, 1999). Pectinase (endo-polygalacturonase from Aspergillus niger, Product No. 17389-50G, Sigma-Aldrich, St. Louis, Mo.) and ascorbic acid (Roche, Nutley, N.J.) were added to the potato slice suspension at 500 unit/1 and 400 ppm, respectively. Potato slices were initially stirred (130 rpm) for 1.5 hr with a 3″ stir bar using a Variomag Tele System Stirring Drive Hp 15, and subjected to further stirring (700 rpm) over the course of 1.5 hr using 1″ stir bars. All stirring was conducted in a controlled temperature water bath maintained at 50° C. to provide optimal conditions for pectinase activity. After 3 hr of total stirring, the potato tissue suspension was cooled to 30° C. in an ice-water bath, and neutralized to pH 6.5-7.0 using 32% (w/v) NaOH. ‘Cell’, ‘Residue’, and ‘Starch’ fractions were processed and recovered as was described in the previous section for the ALK method. However, no ‘Pectin’ fraction was recovered by the ENZ fractionation method, due to the fact that virtually all of the soluble pectin was likely converted to low molecular weight oligosaccharides and monosaccharides during processing of the tissue.

Compositional Analysis of Potato Tissue and Tissue Fractions. Lyophilized reference potato flour and isolated potato parenchyma ‘Cell’ fractions were subjected to moisture, protein, lipid, carbohydrate, ash and total starch analysis. ‘Residue’, ‘Starch’, and ‘Pectin’ fractions were only analyzed for moisture content due to limiting amounts of material.

Moisture contents of all tissue fractions were determined according to AACC Method 44-19 (AACC, 2000). Protein content was estimated using the Dumas nitrogen combustion method by an FP-428 N-Analyzer (Leco Corporation, St. Joseph, Mich.) according to AACC Method 46-30 (AACC, 2000). A conversion factor of 6.25 was used to estimate protein content based on tissue nitrogen levels. Lipid content was analyzed according to AOAC Method 920.39C (AOAC, 1990), using seven to ten grams (dwb) of tissue material and petroleum ether as the extraction solvent. Total starch content was assayed using a Megazyme Total Starch Assay Kit (Wicklow, Ireland) (AACC Method 76-13, AACC, 2000). Ash content was determined according to AACC Method 08-01 (AACC, 2000). Total carbohydrate and non-starch polysaccharide (NSP) contents were calculated by difference.

Thermal Properties of Potato Tissue and Tissue Fractions. Isolated potato parenchyma ‘Cell’ fraction and lyophilized reference potato flour materials were analyzed for gelatinization behavior using a Pyris-1 Differential Scanning calorimeter (DSC) (Perkin Elmer, Norwalk, Conn.). For each analysis, 10 mg (dwb) of potato tissue material was weighed into an aluminum sample pan, followed by the addition of 20 μl of deionized water. Pans were sealed, and equilibrated at ambient temperature (25° C.) overnight. Prepared samples were analyzed from 20° C. to 180° C. at a rate of 10° C. per minute. Onset (To), peak (Tp), completion (Tc) gelatinization temperatures, as well as gelatinization enthalpy (ΔR), were recorded for each sample.

Pasting Properties of Potato Tissue and Tissue Fractions.

Pasting properties of isolated potato parenchyma ‘Cell’ fractions and lyophilized potato flours were analyzed using the Rapid Visco Analyzer (RVA) (Newport Scientific, NSW, Australia). It was necessary to evaluate the ‘Cell’ fractions isolated via ALK and ENZ fractionation methods using two different sample:water ratios. ALK-isolated cells were analyzed at 1.5 g (dwb) in the presence of 26.5 g of deionized water (28.0 g combined weight), while ENZ-isolated cells were tested at 2.1 g (dwb) and 25.9 g of water (total weight of 28 g). Lyophilized potato flour was analyzed at both sample:water ratios as a reference sample. All materials were evaluated using the RVA profile adapted from Batey et al. (1997). Potato tissue suspensions were analyzed under continuous shear (960 rpm for first 30 sec, 160 rpm for the remainder of the analysis) beginning with an initial hold at 50° C., (2 min), linear heating to 95° C. (7.5° C./min), a hold at 95° C. (4 min), linear cooling to 50° C. (11.25° C./min), and a final hold at 50° C. (4 min). Total test time was 20 min.

Experimental Design and Statistical Analysis. The variables of this experiment included two potato cultivars (RB and RN), and two ‘Cell’ fractionation methods (ALK and ENZ). A randomized complete block design was used to generate appropriate experimental replication and also to account for the possible effect of storage time on raw potato tubers (experiments were conducted over a four-week period). The experiment consisted of four blocks (one block=one week), with each block consisting of four experiments (by day) (Table 3). Within an experimental day, only one fractionation method was conducted on both cultivars (RB and RN) in duplicate, and a sequence of testing was randomized. Within a block, each fractionation method was also randomly conducted twice, which gave a total of four replications per block of cultivar-fractionation method combinations.

The mean fraction yields for ‘Cell’, ‘Residue’, ‘Starch’, and ‘Pectin’ fraction of each cultivar-fractionation method combination were calculated based on sixteen total replications. On the other hand, due to limitations of material, proximate analysis, DSC, and RVA analyses were generally conducted using material pooled from within the same block (one block=one sample). This reduced the replications of these tests down to four replications for each cultivar-fractionation method combination. All analyses, but total starch content (two measurements per block), were based on a single measurement per block. All data were statistically analyzed using the Statistical Analysis System (SAS institute, Cary, N.C.). Differences among cultivars and fractionation methods with respect to fractionation yields, proximate compositions, thermal properties, and pasting properties of ‘Cell’ fractions were assessed using Analysis of Variance (ANOVA) based on randomized complete block design, using LS Means for mean separation.

Results and Discussion

Potato Tissue Fraction Yields, Characteristics and Composition

Methods utilized for parenchyma cell isolation in this study yielded up to four primary potato tissue fractions: 1) isolated parenchyma cells (‘Cell’), 2) free starch (‘Starch’), 3) soluble cell wall polysaccharides (‘Pectin’), and 4) extraneous potato tissue residue remaining after fractionation (‘Residue’). Table 4 provides the mean fraction yields for the four isolation conditions studied (two cultivars×two isolation methods). Russet Burbank (RB) and Russet Norkotah (RN) were the two cultivars investigated, while the two fractionation schemes were based on either alkaline (ALK) or enzymatic (ENZ) treatments. Fraction yields for each cultivar/isolation treatment combination were reported on a g/100 g basis, and depict the relative amount of tissue solids recovered from the original raw potato tissue on a dry weight basis (dwb). The total recovered solids (TRS) values comprise the composite sum of the four isolated tissue material fractions (g/100 g of raw potato tissue solids) obtained upon fractionation. From the presented data, it is apparent that not all of the original raw tissue solids were recovered in the fractionation process; this aspect will be discussed in greater detail in later sections. Mean ranges for the potato tissue fraction yields (reported on 100 g raw potato tissue solids basis) across the four isolation conditions were as follows: ‘Cell’, 38.59-55.51 g; ‘Starch’, 15.22-22.88 g; ‘Residue’, 1.17-16.88 g; ‘Pectin’ (only from the ALK method), 3.45-3.90 g; and TRS, 71.86-81.80 g. No matter the cultivar or isolation method, the yield of isolated parenchyma cells (‘Cell’) generally approached or exceeded 40% of the original potato tissue solids used for fractionation. Tissue fraction yields appeared to be influenced by both the cultivar and isolation method employed in the fractionation process.

Potato Tissue Fraction Characteristics. Tissue fractions representing the various isolation schemes were further characterized microscopically to provide insight into their structures and compositions. Primary emphasis was placed upon the isolated ‘Cell’ fraction, which was the principal interest of this study. Isolated ‘Starch’ and ‘Residue’ fractions were briefly characterized by light microscopy, while the ‘Pectin’ fraction was not further purified or characterized in this work.

Using scanning electron microscopy (SEM), isolated ‘Cell’ fractions from the four isolation conditions were shown to consist primarily of intact parenchyma cells, though some occasional broken cells, and extracellular (free) starch granules were also present. Structures of intact cells consisted of clusters of starch granules held together and surrounded by a semi-transparent cell wall. In some cases, cells were still attached to other cells creating multi-cell aggregates. At higher levels of magnification, the cell wall structures surrounding the isolated cells were observed to have a highly shrunken appearance and to be tightly wrapped around and adhered to starch granules. However, no obvious differences between the cell structures of the four cultivar/isolation method series were consistently observed via SEM.

Isolated ‘Cell’ fractions were also observed in the rehydrated state using the light microscope. Under plane-polarized light, starch granules within cells for all cultivars and isolation schemes exhibited native birefringence and the typical polarization cross, confirming that the native crystalline structure of starch granules had not been visibly disrupted by the fractionation schemes. Though no consistent differences were previously noted between parenchyma cells isolated via the two isolation schemes using SEM (dehydrated state), the cell wall structures of parenchyma cells from the two fractionation schemes appeared to differ more substantially in the presence of water. The cell wall structures of ALK-isolated cells swelled and assumed a more rounded shape in the presence of water, while those of the ENZ fractionation scheme remained tightly adhered to starch granules as was observed previously in SEM images. To further investigate the nature of this difference, ruthenium red, which binds selectively to carboxylic acid groups of pectin (Hou et al., 1999), was used to stain and highlight the pectin within the parenchyma cell wall structures representing the two isolation schemes. While pectic substances were detected within the cell wall regions of parenchyma cells isolated via both fractionation schemes, cell walls of ALK-isolated cells appeared to be more highly stained than those of ENZ-isolated cells. Thus, it is possible that differential pectin levels within the middle lamellae could provide some explanation for the disparity in hydration and swelling behaviors of ALK- and ENZ-isolated parenchyma cell wall structures. This possibility is supported by the finding of Kirby et al. (2006), who reported that the sequential extraction of pectic substances from the cell wall region appeared to alter the remaining structural characteristics of parenchyma cell walls. The authors concluded that the removal of pectic substances and xyloglucan from the cell wall likely decreased the subsequent interfiber spacing, resulting from the progressive dehydration and shrinkage of the cell wall fragment. In the current study, it is possible that the ENZ method (relative to that of the ALK) may have removed a greater proportion of pectic substances from the cell wall middle lamella, and that this removal affected the structure and hydration properties of the remaining cell wall constituents.

‘Starch’ and ‘Residue’ fractions were also analyzed via light microscopy to investigate their structures and morphologies. The ‘Starch’ fraction was comprised almost exclusively of free starch granules, which exhibited native birefringence and the typical polarization cross previously observed for starch granules within the cells (data not shown). Both raw material preparation (slicing) and the actual fractionation scheme itself created some broken cells, which generated free starch and reduced the ‘Cell’ yield. The yield of free starch appeared to vary both according to cultivar and the fractionation process. The ‘Residue’ fraction was mainly comprised of fibrous material consisting of aggregates of small parenchyma cells and also bundles of xylem and phloem tissue, suggesting that this tissue likely originated from the vascular ring region of the original tuber. The size of the parenchyma cells and starch granules within the cells comprising the ‘Residue’ fraction was relatively small compared to that of the ‘Cell’ fraction. Also, the cells within the ‘Residue’ fraction generally appeared to be more resistant to separation during fractionation. It could be that the smaller size of the parenchyma cells simply produced a greater collective surface area for adhesion between adjacent cells, resulting in stronger cell-to-cell bonding that hindered cell separation. It has also been reporting that cells in the vascular ring area can possess some secondary cell wall structures (e.g., lignin in xylem area) (Evert, 2006) that could explain the greater resistance of these cells to separation, relative to those of other parts of the tissue. The amount of collected ‘Residue’ differed according to both cultivar and fractionation method.

No pectic material was recovered in the ENZ fractionation method, which degraded pectic substances to lower molecular weight oligosaccharides and sugars. In contrast, pectin was recovered in the ALK fractionation method, which likely aided solubilization of pectic substances of the middle lamella through introduction of negative (repulsive) charges on pectin molecules and the possible promotion of depolymerization via β-elimination reactions. For the ALK method, the solubilized pectic substances were recovered by alcohol precipitation, and were measured gravimetrically. No further analyses were conducted to assess the purity or properties of the recovered pectin fraction. Under the assumption that the ‘Pectin’ fraction consisted entirely of pectic substances, it is estimated that the range of recovered pectin reported in this study represented approximately 35-50% of the pectin present within fresh potato tissue, based on literature values (Turquois et al., 1999) and the indirect determination of non-starch polysaccharides in this study (Table 5).

Potato ‘Cell’ Fraction Composition. As the ‘Cell’ fraction represented the primary focus of this study, this fraction was further analyzed in regard to proximate composition to better understand the effects of the fractionation process conditions on ‘Cell’ fraction macronutrient content. Table 5 provides the mean percentages of lipid, ash, protein, carbohydrate, starch, and non-starch polysaccharides (NSP) for the ‘Cell’ fractions of the four fractionation schemes and the cultivar whole-tissue reference flours (controls), which comprised freeze-dried potato tissue of each cultivar. Mean ranges in composition for the isolated cells were as follows: lipid, 0.04-0.09%; ash, 0.40-0.82%; protein, 1.50-3.67%; carbohydrate, 95.77-97.87%; starch, 82.86-85.63%, and NSP, 10.27-14.18%. With the exception of NSP, all cell compositional values were significantly different from those of potato tissue controls. Isolated parenchyma ‘Cell’ fraction possessed reduced lipid, protein, and ash contents, and increased carbohydrate and starch contents, relative to the whole-tissue control flours. Decreasing levels of lipid, protein, ash, and NSP in isolated parenchyma cells as a result of fractionation had the effect of increasing or concentrating the overall carbohydrate and starch contents relative to the control flours. The loss of ash and protein from cells during fractionation would appear to account for almost half of the unrecovered tissue solids previously noted (Table 4). Fluctuations in ash and protein would be anticipated to occur together, as proteins contain charged groups capable of binding counter ions.

TABLE 4
Mean¹ fraction yields² for the four cultivar-fractionation method combinations

| | | | | | | Total Recovered |
|---|---|---|---|---|---|---|
| Method | Cultivar | Cell | Starch | Residue | Pectin | Solids (TRS) |
| Alkaline | Russet Burbank | 38.59 ± 3.43 ^{d} | 22.88 ± 4.63 ^{a} | 16.88 ± 7.12 ^{a} | 3.45 ± 0.43 ^{b} | 81.80 ± 3.59 ^{a} |
| Alkaline | Russet Norkotah | 45.66 ± 5.67 ^{c} | 19.48 ± 4.03 ^{b} | 3.56 ± 1.57 ^{c} | 3.90 ± 0.41 ^{a} | 72.60 ± 5.85 ^{b} |
| Enzyme | Russet Burbank | 50.60 ± 5.31 ^{b} | 16.26 ± 2.01 ^{c} | 7.78 ± 5.73 ^{b} | n/a³ | 74.63 ± 2.41 ^{b} |
| Enzyme | Russet Norkotah | 55.51 ± 5.49 ^{a} | 15.22 ± 2.23 ^{c} | 1.17 ± 0.65 ^{c} | n/a³ | 71.86 ± 6.34 ^{b} |

¹Means were calculated from a total of sixteen measurements, and mean ± standard deviation values followed by the same letter within a column are not significantly different at p ≦ 0.05
²Reported as g/100 g of raw potato tissue solids
³n/a = not applicable

In contrasting the two isolation schemes (within a cultivar), the ALK method resulted in a slightly greater loss of protein compared to the ENZ method (Table 5). For the ALK method, potato tissue was subjected to strong basic conditions for an extended period of time (pH 12; 10 hr.), while ENZ fractionation occurred under mild acidic conditions (pH 4; 3 hr.). A high pH environment (pH 10) has been previously reported to solubilize up to 100% of protein from potato tissue (Ralet and Guéguen, 2000). While differing pH conditions may explain in part the slight differences in protein content observed between the two fractionation schemes, protein content was dramatically reduced by both fractionation schemes. As expected, losses of NSP varied according to the fractionation method, with ENZ isolated-cells possessing more reduced NSP levels than those isolated by the ALK method. This result corroborates the previous microscopic observations that the cell wall pectin of ENZ-isolated cells was less stained compared to that of ALK-isolated cells. In short, the fractionation process appeared to be influenced by both cultivar and fractionation method effects. To better understand these effects, a more comprehensive statistical analysis was applied.

TABLE 5
Mean¹ proximate compositions (g/100 g) of the isolated parenchyma ‘Cell’ fractions
representing four cultivar-fractionation methods, and whole tissue reference flours

| Method | Cultivar | Lipid | Ash | Protein | Carbohydrate² | starch | NSP³ |
|---|---|---|---|---|---|---|---|
| Alkaline | Russet Burbank | 0.04 ± 0.09 ^{b} | 0.59 ± 0.07 ^{b} | 1.50 ± 0.28 ^{a} | 97.87 ± 0.19 ^{a} | 83.76 ± 1.48 ^{ab} | 14.11 ± 1.52 ^{b} |
| Alkaline | Russet Norkotah | 0.05 ± 0.07 ^{b} | 0.82 ± 0.10 ^{b} | 2.09 ± 0.21 ^{d} | 97.04 ± 0.35 ^{a} | 82.86 ± 1.73 ^{b} | 14.18 ± 1.47 ^{b} |
| Enzyme | Russet Burbank | 0.06 ± 0.06 ^{b} | 0.40 ± 0.12 ^{b} | 2.27 ± 0.18 ^{a} | 97.28 ± 0.12 ^{a} | 85.63 ± 1.33 ^{a} | 11.65 ± 1.37 ^{c} |
| Enzyme | Russet Norkotah | 0.09 ± 0.07 ^{b} | 0.47 ± 0.04 ^{b} | 3.67 ± 0.45 ^{c} | 95.77 ± 0.37 ^{b} | 85.50 ± 1.80 ^{a} | 10.27 ± 1.57 ^{c} |
| Control⁴ | Russet Burbank | 0.18 ± 0.03 ^{a} | 3.78 ± 1.05 ^{a} | 11.70 ± 0.24 ^{b} | 84.34 ± 1.24 ^{c} | 68.49 ± 0.97 ^{c} | 15.85 ± 2.17 ^{b} |
| Control⁴ | Russet Norkotah | 0.18 ± 0.03 ^{a} | 3.98 ± 0.10 ^{a} | 13.41 ± 0.15 ^{a} | 82.44 ± 0.12 ^{d} | 62.18 ± 3.65 ^{d} | 20.26 ± 3.59 ^{a} |

¹Means were calculated from a total of four measurements (exception: starch content was calculated from a total of eight measurements), and mean ± standard deviation values followed by the same letter within a column are not significantly different at p ≦ 0.05
² Carbohydrate was calculated by difference (carbohydrate = 100 − lipid − protein − ash)
³Non starch polysaccharides (NSP) was calculated by difference (NSP = carbohydrate − starch)
⁴Control = lyophilized potato reference flour

Cultivar and Isolation Method Effects on Fraction Yields. Analysis of variance (ANOVA) was performed to assess both cultivar and fractionation method main effects, as well as the potential interaction between the two main effects, on material fraction yields (Table 6). Cultivar significantly influenced the yields of all collected fractions, while isolation method significantly affected all material fractions aside from pectin (was only recovered for the ALK method). Significant interactions between cultivar and fractionation method were only observed for the ‘Residue’ and the TRS attributes. However, upon plotting, it was noted that these interactions were non-severe (lack of crossover effects), as the overall trends observed in response to treatments were consistent for both cultivars. Therefore, only the main effects were considered.

Mean values for the various tissue fraction yields (g/100 g of raw potato tissue solids) were compared according to cultivar (pooled across two isolation methods) (Table 7). On average, a greater proportion of ‘Cell’ material (and a corresponding lesser proportion of ‘Residue’ material) was isolated for RN relative to RB. Thus, the RB tissue appeared to be more resistant to separation into individual parenchyma cells than that of RN. A possible reason for this behavior may be related to cultivar differences in the amount and/or nature of pectic substances within the middle lamella. A slightly higher amount of pectin was recovered for RN relative to RB for the ALK fractionation scheme (Table 7), supporting this possibility. In addition, RN experienced a greater proportional loss of NSP than RB (relative to their respective whole-tissue controls) regardless of the fractionation scheme (Table 5), providing further evidence for the possible role of pectic substances in cell separation. Cultivar also significantly affected ‘Starch’ fraction yields, with RB yielding slightly more free starch than RN (Table 7). This difference is likely based in the fact that RB tissue possessed a greater solids and starch content than that of RN (Table 5, see whole-tissue controls), with greater amounts of starch being released from broken cells during the slicing and fractionation processes.

TABLE 7
Mean¹ fraction yields by cultivar and fractionation method

| Condition | Cultivar/Method | Cell² | Residue² | Pectin² | Starch² | TRS² |
|---|---|---|---|---|---|---|
| Cultivar | Russet Burbank | 44.59 ± 7.52 ^{b} | 12.33 ± 7.86 ^{a} | 3.45 ± 0.43 ^{b} | 19.57 ± 4.86 ^{a} | 78.21 ± 4.72 ^{a} |
| | Russet Norkotah | 50.59 ± 7.43 ^{a} | 2.34 ± 1.71 ^{b} | 3.91 ± 0.41 ^{a} | 17.35 ± 3.87 ^{b} | 72.23 ± 6.01 ^{b} |
| Method | Alkaline | 42.12 ± 5.85 ^{b} | 10.22 ± 8.46 ^{a} | 3.68 ± 0.47 | 21.18 ± 4.61 ^{a} | 77.20 ± 6.68 ^{a} |
| | Enzyme | 53.06 ± 5.87 ^{a} | 4.45 ± 5.25 ^{b} | n/a³ | 15.74 ± 2.15 ^{b} | 73.24 ± 4.92 ^{b} |

¹Means pooled across methods and cultivars, and were calculated from a total of thirty two measurements (exception: pectin contents within cultivar row were calculated from a total of sixteen measurements): mean ± standard deviation values followed by the same letter within column are not significantly different at p ≦ 0.05.
²Reported as g/100 g of raw potato tissue solids
³n/a = not applicable

The TRS means for RB and RN were 78.2 g and 72.2 g, respectively, indicating that RN tended to lose relatively more tissue solids during fractionation. It was noted that the starch contents of the control potato tissue flours generally declined over the course of the four week experimental period, during which time tubers were stored at 4° C. (cold sweetening effect). This decline was much more pronounced for RN tubers compared to those of RB (Table 8), for which tissue starch content did not differ significantly over the four week storage period. RN has been reported to exhibit a greater tendency toward cold sweetening than RB. As a result, the greater starch to sugar conversion for RN (relative to RB) likely translated into a relatively higher proportion of soluble solids, which were more readily lost during the fractionation process. Thus, the cold sweetening effect likely contributed to the overall loss of tissue solids during fractionation, and explained in part the relative differences in TRS between RN and RB cultivars.

Mean fraction yields by method are also provided in Table 7 (g/100 g of raw potato tissue solids). The ENZ method yielded a ‘Cell’ fraction mean value of 53.06 g compared to 42.12 g for the ALK method. Conversely, the ALK method yielded more ‘Residue’ than the ENZ method, indicating that the ENZ method was able to separate potato tissue into parenchyma cells more effectively than the ALK method (with less remaining ‘Residue).

This finding is likely explained in part by the fact that cultivar NSP levels of ‘Cell’ fractions isolated by the ENZ process were significantly lower than those isolated by the ALK method (Table 5). It is believed that the ENZ method was able to remove a greater proportion of the pectic substances from the cell wall middle lamellae compared to the ALK method. While the ENZ method was conducted under optimum conditions (pH and temperature) for maximal polygalacturonase activity, the ALK method was not able to be completely optimized for the β-elimination reaction (depolymerization) without gelatinizing the starch (temperature had to be maintained at less than 30° C. in the presence of the added base). Thus, conditions for pectin depolymerization were somewhat limited for the ALK method.

However, no direct statistical comparison of recovered pectin was possible between the ALK and ENZ methods following fractionation. Since most of the pectin in the ENZ method was hydrolyzed to soluble oligosaccharides and sugars during fractionation, pectic substances were not recovered by the ENZ method (Table 7). Differences in TRS for the two methods appeared to coincide with differences in the amounts of recovered pectin. The 3.68 g of pectin recovered in the ALK method coincided very closely with the observed difference in TRS between two methods (3.96 g). While the ENZ (relative to the ALK) method appeared to produce the greatest ‘Cell’ fraction yields under the conditions investigated in this study, the ALK method had the specific advantage of yielding an intact and recoverable pectin fraction.

In further comparing the two methods, a greater amount of free starch was obtained by the ALK relative to the ENZ method. The basis for this observation is likely explained by differences in the length of mechanical stirring for the two methods (10 hr for ALK; 3 hr for ENZ). An extended length of stirring was observed to break parenchyma cell walls, resulting in increased levels of free starch. This phenomenon was observed in preliminary studies, which showed that the free starch levels increased with increasing lengths of mechanical stirring (data not shown).

In summary, the overall results showed that both cultivar and fractionation conditions significantly affected ‘Cell’ fraction yields and composition. In terms of ‘Cell’ fraction yields, RN was more productive than RB, most likely due to cultivar differences in the characteristics and structures of pectic substances within the middle lamella. For the comparison of fractionation methods, the ENZ method performed significantly better than the ALK method in terms of ‘Cell’ yield. However, the ALK method offered the advantage of recovering pectin solubilized during the fractionation process.

Thermal Properties of the ALK and ENZ ‘Cell’ Fractions. The thermal properties of the isolated potato ‘Cell’ fractions were analyzed using differential scanning calorimetry (DSC) to observe the gelatinization properties of the starch within the isolated parenchyma cells. Onset (To), peak (Tp), and completion (Tc) gelatinization temperatures, as well as values for gelatinization enthalpy (ΔR), are provided in Table 9 for the ‘Cell’ fractions representing the four cultivar-isolation schemes. Whole-tissue (control) flours for each cultivar were included as a comparative reference. The two control flours (RB and RN) possessed similar gelatinization enthalpies and exhibited comparable gelatinization temperature ranges, but differed in their onset gelatinization temperatures. The onset, peak and completion gelatinization temperatures for the RB control flour were shifted approximately 6° C. lower than those of RN. Most of the thermal properties of the isolated ‘Cell’ fractions were significantly different from those of their respective whole-tissue control flours, especially in regard to gelatinization enthalpy values. The isolated ‘Cell’ fractions all possessed higher enthalpy values than the control flours. The most obvious and probable reason for this observation had to do with the concentration of starch within the isolated ‘Cell’ fractions due to the loss of soluble solids (protein, lipid, sugar and minerals, etc.) during fractionation (higher starch levels=higher enthalpy). In contrasting starch gelatinization temperatures, the isolated ‘Cell’ fractions generally tended to undergo starch gelatinization at lower temperatures than their respective whole-tissue control flours, with the exception of the RB ‘Cell’ fraction, which exhibited a higher To than the control RB flour (specific reason for this exception will be discussed at a later point). Previous studies have shown that various non-starch potato tissue components have potential to influence potato starch gelatinization characteristics. Liu et al. (2007) compared the starch gelatinization properties of whole-tissue potato flour and potato starch, and reported that the gelatinization temperatures of the potato flour were higher than those of isolated potato starch extracted from the same potato tissue. McComber et al. (1988) similarly showed that the gelatinization temperatures of potato starch in the presence potato juice extract were higher than those of the same potato starch gelatinized in water. Suzuki and Hizukuri (1979) reported that the potato juice extract inhibits the gelatinization of potato starch, and hypothesized that inorganic ions within the soluble solids fraction may have caused this phenomenon through promotion of enhanced molecular associations within starch granules. Thus, it is likely that the general trend of reduced gelatinization temperatures for the isolated ‘Cell’ fractions (relative to their respective whole-tissue controls) is explained in part by the loss of potato tissue soluble solids during the fractionation process. However, other more specific differences between the gelatinization properties of the whole-tissue control flours and their respective isolated ‘Cell’ fractions appeared to be a function of the specific conditions inherent to the two isolation methods. These differences will be discussed in the following paragraphs.

TABLE 8
Cultivar mean¹ percentages of total starch within control
potato flours during the four-week experimental period

| | |
|---|---|
| Experimental | Starch Content (%) |

| period | Russet Burbank | Russet Norkotah |
|---|---|---|
| Week 1 | 69.36 ± 1.39 ^{a} | 66.38 ± 1.12 ^{a} |
| Week 2 | 69.12 ± 0.74 ^{a} | 63.38 ± 0.50 ^{b} |
| Week 3 | 67.21 ± 0.75 ^{a} | 61.28 ± 0.90 ^{b} |
| Week 4 | 68.28 ± 0.19 ^{a} | 57.69 ± 1.19 ^{c} |

¹Mean within a block were calculated from a total of two measurements, and mean ± standard deviation and values followed by the same letter within a column are not significantly different at p ≦ 0.05.

TABLE 9
Means¹ of the thermal properties ‘Cell’ fractions representing the
four cultivar-fractionation methods, and whole tissue control flours

| Method | Cultivar | Tₒ (° C.) | Tₚ (° C.) | T_{c} (° C.) | ΔH (J/g) | Range (° C.) |
|---|---|---|---|---|---|---|
| Alkaline | Russet Burbank | 59.37 ± 0.17 ^{f} | 63.84 ± 0.18 ^{d} | 74.35 ± 0.67 ^{d} | 13.73 ± 0.96 ^{a} | 14.98 ± 0.67 ^{a} |
| Alkaline | Russet Norkotah | 64.30 ± 0.40 ^{c} | 69.41 ± 0.40 ^{b} | 80.26 ± 0.50 ^{b} | 12.72 ± 0.66 ^{a} | 15.96 ± 0.30 ^{a} |
| Enzyme | Russet Burbank | 63.30 ± 0.56 ^{d} | 66.55 ± 0.84 ^{c} | 75.10 ± 1.19 ^{d} | 13.65 ± 1.38 ^{a} | 11.79 ± 0.75 ^{c} |
| Enzyme | Russet Norkotah | 66.03 ± 0.33 ^{b} | 70.03 ± 0.48 ^{b} | 79.88 ± 0.56 ^{b} | 13.16 ± 0.41 ^{a} | 13.86 ± 0.30 ^{b} |
| Control² | Russet Burbank | 61.32 ± 0.18 ^{e} | 66.72 ± 0.12 ^{c} | 76.94 ± 0.97 ^{c} | 10.97 ± 0.96 ^{b} | 15.62 ± 1.05 ^{e} |
| Control | Russet Norkotah | 67.97 ± 1.02 ^{a} | 73.56 ± 0.79 ^{g} | 83.27 ± 0.54 ^{a} | 10.84 ± 0.62 ^{b} | 15.30 ± 1.06 ^{a} |

¹Means were calculated from a total of four measurements, and mean ± standard deviation and values followed by the same letter within a column are not significantly different at p ≦ 0.05.
²Control = lyophilized potato reference flour

As presented in Table 9, the effect of fractionation method on ‘Cell’ thermal properties was clearly evident. As noted and discussed in the previous paragraph, the ALK method did not significantly alter the gelatinization temperature range for the isolated ‘Cell’ fractions relative to those of the whole-tissue control flours. Nevertheless, the values for To, Tp, and Tc for the ALK RB and RN ‘Cell’ fractions were consistently 2-4° C. lower than those of their respective whole-tissue control flours. While some explanation for this observation was provided in the previous paragraph (loss of soluble tissue solids), it is also possible that the high alkaline environment of the ALK process itself might have disrupted starch molecules within the amorphous regions of granules, causing them to experience a greater degree of molecular mobility at a slightly lower temperature. As starch gelatinization is a cooperative process (mobility of starch within the granule amorphous regions exerts strain on starch comprising the crystalline regions to bring about melting), a greater degree of molecular mobility within the granule amorphous regions could cause a downward shift in the gelatinization temperature without extending or narrowing the overall gelatinization temperature range. It does not appear that starch crystalline regions themselves were directly disrupted by the alkaline conditions of the ALK method, as gelatinization enthalpies for the ALK and ENZ (not subjected to alkaline conditions) ‘Cell’ fractions did not significantly differ. Thus, in summary, the decrease in To, Tp, and Tc experienced by the RB and RN ALK ‘Cell’ fractions (relative to their respective whole-tissue controls) was likely explained by the loss of soluble solids during the fractionation process and the possible disruption of starch within the granule amorphous regions due to alkaline treatment.

As was previously discussed for the ALK method, the ‘Cell’ fractions isolated via the ENZ method were also subject to the loss of soluble solids during the fractionation process. However, only the RN ENZ ‘Cell’ fraction exhibited a decreased onset gelatinization temperature relative to its whole-tissue control flour, and the relative difference between the RN ‘Cell’ fraction and control flour was less than that which was observed between the ALK ‘Cell’ and whole-tissue control fractions. In contrast, the RB ENZ actually possessed an onset gelatinization temperature that exceeded that of its corresponding whole-tissue control flour. It was interesting to further note that both RB and RN ENZ ‘Cell’ fractions exhibited significantly reduced gelatinization ranges compared to both their respective whole-tissue control flours and ALK ‘Cell’ fractions. It became apparent that there was a counteracting effect at work specific to the ‘Cell’ fractions isolated by the ENZ method. ‘Cell’ fractions isolated by the ENZ fractionation scheme were held at a temperature of 50° C. for a period of 3 hr to provide optimum conditions for pectinase activity. It has been shown in previous studies that annealing (holding a starch at a temperature just below that of gelatinization) can bring about a narrowing of the gelatinization range of a starch by promoting rearrangement and perfection of its crystalline structure (Tester et al., 2005; Vermeylen et al., 2006; Kohyama and Sasaki, 2006). As a result of crystallite perfection, an annealed starch would be expected to gelatinize over a narrower temperature range relative to a non-annealed starch. Compared to its whole-tissue control flour, the RB ENZ ‘Cell’ fraction had both a higher. To and a slightly reduced Tc, accounting for the narrowed gelatinization range. For the RN ENZ ‘Cell’ fraction, there was a reduction in Tc relative to its whole-tissue control flour as a result of annealing. Though the gelatinization ranges of the ENZ ‘Cell’ fractions of both cultivars were narrower than their respective whole-tissue controls, the relative reduction in gelatinization range for the RB ENZ ‘Cell’ fraction was greater than that of the RN ENZ ‘Cell’ fraction. Thus, the annealing effect appeared to be greater for RB. In the case of the RB ENZ ‘Cell’ fraction, the annealing effect was sufficient to counter and overcome the effect associated with the loss of tissue solids, which effect was previously shown to result in a decrease in To, Tp, and Tc.

In short, both the ENZ and ALK methods were shown to affect the thermal properties of the starch within the isolated ‘Cell’ fractions. The loss of soluble solids during the fractionation process appeared to influence both methods in similar fashion, though other factors specific to each method were also evident. The ENZ method led to annealing of starch, while the alkaline conditions of the ALK method appeared to alter starch structure within granule amorphous regions.

Pasting Properties of the ALK and ENZ ‘Cell’ Fractions.

The ‘Cell’ fractions obtained from both the ALK and ENZ isolation schemes were analyzed using the Rapid Visco Analyzer (RVA) to compare their pasting properties. The pasting profiles of RN ALK and RN ENZ ‘Cell’ fractions tested at a sample weight of 1.5 g showed that the RN ENZ ‘Cell’ fraction was not able to generate any significant viscosity over the entire course of the RVA analysis, and failed to generate a traditional pasting curve. As a result, no pasting properties for the RN ENZ ‘Cell’ fraction could be obtained. However, using these same test parameters, the RN ALK ‘Cell’ fraction produced a valid pasting curve. An attempt was made to evaluate the pasting properties of the ALK and ENZ ‘Cell’ fractions at an increased sample weight (2 g) to overcome the previous challenges. While the 2 g sample weight did produce a valid pasting profile for the ENZ ‘Cell’ fraction, this same sample weight produced a highly viscous gel that was not capable of being measured by the RVA for the ALK ‘Cell’ fraction (data not shown). Thus, under these test conditions, pasting properties for the ALK ‘Cell’ fraction could not be obtained.

The pasting profile in revealed another interesting result. The beginning viscosity value for the RN ALK ‘Cell’ fraction registered 50 RVU above the baseline, indicating that the RN ALK ‘Cell’ fraction generated a measurable viscosity upon simple hydration in water (prior to temperature development). In contrast, the initial viscosity for the RN ENZ ‘Cell’ fraction did not rise above the baseline until significant heating had occurred (due to starch gelatinization). According to microscope results discussed previously, there appeared to be an observable swelling difference between the ALK and ENZ ‘Cell’ fractions upon simple hydration in water. The cell wall materials of the ALK ‘Cell’ fraction appeared to swell significantly when hydrated in ambient temperature water, while those of the ENZ ‘Cell’ fraction remained tightly adhered to starch granules upon hydration. Thus, the initial baseline viscosity observed for the ALK ‘Cell’ fraction during RVA analysis appeared to arise from the swelling of parenchyma cell walls upon hydration, and did not appear to be associated with the swelling of starch granules inside the cells (initial temperature of the pasting profile, 50° C., is not enough to swell/gelatinize starch granules). The swelling of the parenchyma cell walls of the ALK ‘Cell’ fraction likely led to an increase in the volume fraction occupied by the cells, producing a measurable increase in the initial baseline viscosity for the ALK ‘Cell’ fraction.

In further summarizing the differences between the two fractionation methods, the pasting viscosities of ENZ ‘Cell’ fraction seemed to be inhibited to a much greater degree than those of the ALK ‘Cell’ fraction over the course of the entire pasting curve. In a previous study, Kirby et al. (2006) concluded that the removal of pectic substances and xyloglucan from the cell wall likely decreased the interfiber spacing, resulting in the progressive dehydration and shrinkage of the cell wall fragment. The greater removal of pectic substances from the parenchyma cells of the ENZ ‘Cell’ fraction (relative to that of the ALK ‘Cell’ fraction) appeared to result in a strengthening of the cell wall, leading to a reduced pasting viscosity over the entire span of the pasting profile. Thus, based on these preliminary pasting experiments, it was discovered that the ALK and ENZ ‘Cell’ fractions were not able to be analyzed using equal sample weights due to unanticipated differences in their swelling and pasting characteristics. For all further discussions and comparisons of ‘Cell’ fraction pasting properties in this section, RVA analysis for ENZ ‘Cell’ fractions was conducted using 2.1 g of material, while that for ALK ‘Cell’ fractions utilized 1.5 g of material. All other RVA run parameters (aside from sample weight) were kept constant for both the ALK Cell and ENZ ‘Cell’ fractions. This scenario provided the advantage of being able to evaluate the ALK and ENZ ‘Cell’ fractions at concentrations that resulted in generation of valid pasting profiles. The disadvantage of this approach was that direct quantitative comparison of pasting property values between the ALK and ENZ ‘Cell’ fractions was not possible. However, it was still be possible to compare the two fractionation methods in regard to their general pasting trends.

The mean pasting curves for ‘Cell’ fractions of RN and RB cultivars fractioned by the ALK and ENZ methods were also prepared. Mean curves were based on quadruplicate RVA measurements, with one measurement conducted on a weekly basis over the course of the four-week experimental period. In comparing the ‘Cell’ fraction pasting profiles of the two cultivars for a given fractionation method, it was interesting to note that the RN ‘Cell’ fraction consistently possessed higher viscosity values at virtually all points of the pasting curve relative to the RB ‘Cell’ fraction. As noted previously, the ‘Cell’ fractions of both cultivars isolated by the ALK method exhibited initial pasting viscosities (prior to heating) that registered above the zero base-line, though the effect was greater for RN compared to RB. Mean pasting property values for peak, trough, breakdown, setback, and final viscosities of ALK and ENZ ‘Cell’ fractions are also shown in Table 10. It was observed that the standard deviations for the mean pasting properties of the RN ‘Cell’ fractions were always substantially higher than those of the RB ‘Cell’ fractions, when compared according to the same fractionation methods. This result implied that there were some unexplained factors that appeared to disproportionately influence the consistency of the pasting property measurements of the RN ‘Cell’ fraction over the course of the four-week experimental period.

TABLE 10
Mean¹ RVA pasting properites² of ‘Cell’ fractions representing
the four cultivar-fractionation methods combinations

| | | Peak | Trough | Breakdown | Setback | Final |
|---|---|---|---|---|---|---|
| Method | Cultivar | Viscosity² | Viscosity | Viscosity | Viscosity | Viscosity |
| Alkaline | Russet Burbank | 69.65 ± 20.58 ^{b} | 61.54 ± 15.77 ^{a} | 8.08 ± 4.90 ^{b} | 21.06 ± 4.68 ^{b} | 82.63 ± 20.35 ^{a} |
| Alkaline | Russet Norkotah | 135.40 ± 31.87 ^{a} | 72.81 ± 18.73 ^{a} | 62.58 ± 31.21 ^{a} | 69.03 ± 22.31 ^{a} | 141.83 ± 29.59 ^{a} |
| Enzyme | Russet Burbank | 47.67 ± 12.56 ^{b} | 43.88 ± 14.54 ^{a} | 3.79 ± 4.41 ^{b} | 33.98 ± 7.91 ^{a} | 77.85 ± 21.06 ^{a} |
| Enzyme | Russet Norkotah | 137.63 ± 83.07 ^{a} | 93.00 ± 47.05 ^{a} | 44.63 ± 37.70 ^{a} | 66.00 ± 36.91 ^{a} | 159.00 ± 81.99 ^{a} |

¹Means were calculated from a total of four measurements, and mean ± standard deviation and values followed by the same letter within a column and same method are not significantly different at p ≦ 0.05
²All viscosity values were reported in RVU (rapid viscosity units), and 1 RVU equals to 12 centipoise (cP).

To further investigate the source of this variation, all four of the individual pasting curves (representing the four week experimental period) for each fractionation method/cultivar combination were plotted separately. While all fours sets of pasting curves exhibited some variation across the four-week experimental period, the RN ‘Cell’ fractions (regardless of the fractionation method) appeared to exhibit the greatest variation. Moreover, the pasting variation associated with the RN ‘Cell’ fractions appeared to be systematic in nature, as there was a general increase in the viscosity values of the pasting profiles over the four-week experimental period. In contrast, pasting variation for the RB ‘Cell’ fractions were much more minor, and appeared to be random in nature (as opposed to systematic). The reason behind the variation associated with the pasting properties of the RN ‘Cell’ fractions over the four-week experimental period was believed to result from the effects of cold sweetening, which was observed to impact RN to a greater extent than RB (Table 8).

To further investigate this possibility, the whole-tissue control flours of both cultivars were subjected to RVA analysis. In doing so, it is important to note that the tissue structure of the control flours is vastly different from that of the isolated ‘Cell’ fractions within this study. The cellular structures of the isolated ‘Cell’ fractions (with starch granules contained within cells) have already been described in previous discussions. In contrast, the control flours did not possess any remaining cellular structure (due to the fact that they had been freeze dried and subjected to extensive dry grinding). Thus, for the whole-tissue control flours, the starch within these flours was no longer contained within parenchyma cells, but existed as free starch granules within the ground tissue. Because the whole-tissue control flour contained only free starch (was not confounded by the effects of being encased within cell structures), it was expected to be much more sensitive to detecting starch fluctuations within the tissue (as measured by the RVA) due to cold sweetening. In this scenario, a decrease in starch content would be expected to result in decreased RVA viscosity values across the pasting profile. The pasting curves of the RN control flours over the four-week period of the experiment showed a general trend toward decreased pasting profile viscosities over the course of the four-week period for RN. Though the pasting properties of the RB control flour showed some variation, the variation was quite small relative to that observed for the RN control flour. In short, as the starch content decreased, the pasting viscosities of the control flours were correspondingly reduced. This RVA result supported the previous observation that the starch content of RN flour decreased over the course of the four-week experimental period (Table 8).

Interestingly, the direction of the variation observed in the RVA pasting curves of the RN ALK and ENZ ‘Cell’ fractions, in response to a decreasing starch content, was opposite of that observed for the RN control flour. As starch levels in the RN ALK and ENZ ‘Cell’ fractions decreased over the four-week experimental period, their pasting viscosities actually increased. It is hypothesized that the observed increases in the pasting viscosities of the RN ALK and ENZ ‘Cell’ fractions over the course of the experimental period were associated with increases in parenchyma cell numbers. It is anticipated that the decrease in starch content over the course of the experimental period translated into increased numbers of parenchyma cells per unit weight of dry material within the RN ALK and ENZ ‘Cell’ fractions. In this scenario, a greater number of the intact cells per unit volume (within an RVA test volume) would lead to higher viscosity values, since a greater number of cells would occupy a greater volume fraction of the liquid. Conversely, another plausible explanation for the observed pasting behaviors of the ‘Cell’ fractions as a function of cold sweetening might be physicochemical changes occurring within the cell wall structure itself. Such changes could result in the weakening of the cell wall structure to allow greater swelling of parenchyma cells during RVA pasting to occupy an increased volume fraction of the liquid, thus, increasing the viscosity. However, there was no evidence of differences in the cell wall structures of RN ‘Cell’ fractions over the four-week experimental period, based on microscopic observation. In either of the proposed scenarios, the viscosity of intact parenchyma cell dispersions might not be determined just by the level of the starch inside the cells (there is likely more starch present within cells than is needed to maintain internal cell rigidity), but rather by the properties of the cell wall components themselves (e.g., size, swelling behavior, rigidity, etc.).

In summary, both cultivars and fractionation methods exhibited significant effects on ‘Cell’ fraction swelling and pasting properties. The specific ‘Cell’ fractionation method used (ALK vs. ENZ) was believed to differentially affect the physicochemical properties of the cell wall and the subsequent pasting properties of ‘Cell’ fractions. As a result, the ENZ ‘Cell’ fractions exhibited more inhibited pasting viscosities than those of the ALK ‘Cell’ fractions. On the other hand, the ALK ‘Cell’ fractions appeared to be more prone to swelling in the presence of water, which swelling resulted in the generation of measurable viscosity prior to starch gelatinization. The effect of cold sweetening over the course of the four-week study was suspected to be the cause for pasting differences observed between the cultivars. The cold-sweetening effect had a greater relative impact on RN as opposed to RB ‘Cell’ fraction pasting properties, as cultivar differences became increasingly pronounced over the course of the four-week study.

### SUMMARY AND CONCLUSIONS

Results confirmed that degradation of the middle lamella within potato parenchyma tissue at temperatures, below those of potato starch gelatinization can result in the satisfactory yields (40-60% yields) of isolated potato parenchyma cells. Moreover, these methods allowed starch within the cells to be retained in the ungelatinized state. Fractionation conditions (cultivars and methods) were clearly shown to affect the efficiency of the isolation processes. In terms of ‘Cell’ yield, the ENZ method performed significantly better than ALK method, while RN was more productive than RB. Fractionation conditions also produced differential effects on the chemical and physical characteristics of the isolated ‘Cell’ fractions.

The ENZ ‘Cell’ fractionation method appeared to remove greater amount of pectic substances from the cell wall middle lamella relative to the ALK ‘Cell’ fractionation method. The cell walls of the ENZ ‘Cell’ fraction were less prone to swelling in a hydrated environment than those of the ALK ‘Cell’ fraction. The greater reduction of pectic substances in the ENZ ‘Cell’ fraction is hypothesized to alter the native arrangement of the cell wall structure, allowing it to be rearranged into a denser packing arrangement. This change in cell wall structure could explain the relative reduction in the ENZ ‘Cell’ fraction pasting viscosity, compared to that of the ALK ‘Cell’ fraction. The rheological behavior of the ‘Cell’ fractions was more a function of the cell wall characteristics than starch content. Nevertheless, the fractionation methods were also observed to impact the thermal properties of the starch within the various ‘Cell’ fractions. The ENZ method influenced starch properties within cells via an annealing process, which led to the alteration of the starch gelatinization temperature and a narrowing of the starch gelatinization temperature range. The ALK method was suspected to affect the amorphous region of starch granule due to exposure to alkaline condition, leading to a reduction in gelatinization temperatures.

Cultivars also affect composition, thermal properties, and pasting properties of the ‘Cell’ fractions. However, these differences between the RB and RN ‘Cell’ fractions were due mostly to the effect of the cold sweetening during raw material storage, with RN tending to be more susceptible to the cold sweetening than RB. As a result, the RN ‘Cell’ fractions tended to exhibit greater variation in starch content and the pasting properties than the RB ‘Cell’ fractions. Without the cold sweetening effect, differences between cultivars in regard to their ‘Cell’ fraction compositions and pasting properties were minor. Though some differences in the thermal properties of the RN and RB ‘Cell’ fractions were observed, these fluctuations, however, were more a function of differences in the native starch structures than effects from cold sweetening.

In conclusion, the ENZ fractionation method combined with the RN potato cultivar was shown to generate the highest ‘Cell’ fraction yields of the combination studied. However, the effect of the fractionation method was more pronounced than that of cultivar. Pectin was able to be recovered as a byproduct in the ALK fractionation method. In this study, the cold sweetening effect, which was considered an interfering effect due to raw material storage conditions, also influenced in the properties of the isolated ‘Cell’ fraction.

### Example 3

### Separation and Isolation of Intact Parenchyma Cells from Raw (Uncooked) Potato (Solanum tuberosum) Tissue

Resistant starch (RS) consists of starch material that passes undigested through the small intestine into the large intestine (Englyst, et al., 1992), where it is fermented by bacterial microflora within the colon into short-chain fatty acids and other secondary metabolites, contributing demonstrated physiological benefits (Champ, 2004; Wong and Jenkins, 2007; Topping, 2007; Sharma et al., 2008).

Within native potato tissue, starch granules undergo swelling and gelatinization (loss of molecular order) during cooking, rendering gelatinized starch readily digestible. Consequently, cooked potato tissue retains little RS.

Nevertheless, potato starch in its native granular form in raw potato tissue is extremely resistant to human digestion (RS-type 2), and is further encased within a cell wall structure (i.e., physical barrier, potential source of RS-type 1). To date, most commercial RS products are based on isolated starch, rather than whole-tissue food materials.

The ability to produce potato tissue-based ingredients with enhanced RS content (and potentially moderated glycemic response) represents a whole-food approach to RS formation, and provides a prime opportunity to diversify and create new markets for potato products.

Factorial Experimental Design (22): Parenchyma Cell Isolation

Two cultivars: Russet Burbank (RB) and Russet Norkotah (RN)

Two isolation methods: 1) Alkaline treatment (ALK): Incubation of raw potato tissue in 0.08 M NaOH containing sodium hexametatphosphate (0.75%, w/v) at 25° C. for 10 hr, and 2) Enzyme treatment (ENZ): Incubation of raw potato tissue in pectinase (500 units/I) in citrate buffer (pH 4.1) at 50° C. for 3 hr

The ALK and ENZ tissue separation methods yielded 4 and 3 material fractions, respectively: Isolated Parenchyma Cells (‘Cell’); Free Starch Granules (‘Starch’); Remaining Tissue (‘Residue’); and Solubles (designated as ‘Pectin’: ALK method only). The experiment consisted of 16 total replications.

Analytical methods (only ‘Cell’ fractions were characterized).

‘Cell’ Composition: Lipid (Soxhlet, AOAC Method 920.39C); Protein (nitrogen combustion, AACC Method 46-30), Ash (AACC Method 08-01); Carbohydrate (by difference); Total Starch (AACC Method 76-13); Non-Starch Polysaccharide (NSP, determined by difference [Carbohydrate-Total Starch]); Resistant starch (AACC Method 76-13).

Thermal Properties (DSC): 10 mg of ‘Cell’ material in 20 μl of water heated from 20-180° C. (10° C./minute).

Scanning Electron Microscopy (SEM): ‘Cell’ material (gold/palladium-coated) viewed at 3 kV.

Results and Discussion

Potato Tissue Fraction Yields

No matter the cultivar or isolation method, yields of isolated ‘Cell’ fractions approached or exceeded 40% of the original potato tissue solids, with ‘Cell’ fraction yields generally being inversely proportional to the amount of remaining tissue ‘Residue’ (Table 1).

Not all of the original potato tissue solids were recovered in the collected fractions (i.e., ‘Cell’, ‘Starch’, ‘Residue’, ‘Pectin’), implying that some potato solids were lost in the fractionation process (Table 1).

TABLE 1
Mean¹ fraction yields for the four cultivar-fractionation method combinations

| | | | | | Total Recovered |
|---|---|---|---|---|---|
| Cultivar/Method | Cell² | Starch² | Residue² | Pectin² | Solids (TRS)² |
| RB³ ALK⁴ | 38.59 ± 3.43 ^{d} | 22.88 ± 4.63 ^{a} | 16.88 ± 7.12 ^{a} | 3.45 ± 0.43 ^{b} | 81.80 ± 3.59 ^{a} |
| RN³ ALK¹ | 45.66 ± 5.67 ^{c} | 19.48 ± 4.03 ^{b} | 3.56 ± 1.57 ^{c} | 3.90 ± 0.41 ^{a} | 72.60 ± 5.85 ^{b} |
| RB³ ENZ¹ | 50.60 ± 5.31 ^{b} | 16.26 ± 2.01 ^{c} | 7.78 ± 5.73 ^{b} | n a⁵ | 74.63 ± 2.41 ^{b} |
| RN³ ENZ⁴ | 55.51 ± 5.49 ^{a} | 15.22 ± 2.23 ^{c} | 1.17 ± 0.65 ^{c} | n a⁵ | 71.86 ± 6.34 ^{b} |

¹Mean values were calculated from a total of sixteen measurements, mean ± standard deviation values followed by the same letter within a column are not significantly different (p [symbol] 0.05).
²g 100 g raw potato tissue solids (based on the potato tissue used in the initial fractionation)
³RB = Russet Burbank. RN = Russet Norkotah
⁴ALK = Alkaline Isolation Method. ENZ = Enzyme Isolation Method
⁵n a = not applicable [symbol]
indicates data missing or illegible when filed

In comparing the two potato cultivars (Table 2):

RN yielded a greater proportion of ‘Cell’ fraction material (and consequently lesser amount of ‘Residue’) and a slightly greater amount of ‘Pectin’ compared to RB.

RB generated slightly more ‘Starch’, and produced a higher recovery of solids

TABLE 2
Mean¹ fraction yields by cultivar and fractionation method

| | | | | | Total Recovered |
|---|---|---|---|---|---|
| Condition | Cell² | Residue² | Pectin² | Starch² | Solids (TRS)² |
| Cultivar | | | | | |
| RB³ | 44.59 ± 7.52 ^{b} | 12.33 ± 7.86 ^{a} | 3.45 ± 0.43 ^{b} | 19.57 ± 4.86 ^{a} | 78.21 ± 4.72 ^{a} |
| RN³ | 50.59 ± 7.43 ^{a} | 2.34 ± 1.71 ^{b} | 3.91 ± 0.41 ^{a} | 17.35 ± 3.87 ^{b} | 72.23 ± 6.01 ^{b} |
| Method | | | | | |
| ALK⁴ | 42.12 ± 5.85 ^{b} | 10.22 ± 8.46 ^{a} | 3.68 ± 0.47 | 21.18 ± 4.61 ^{a} | 77.20 ± 6.68 ^{a} |
| ENZ⁴ | 53.06 ± 5.87 ^{a} | 4.45 ± 5.25 ^{b} | n/a⁵ | 15.74 ± 2.15 ^{b} | 73.24 ± 4.92 ^{b} |

¹Mean values pooled across methods and cultivars, and were calculated from a total of thirty two measurements (exception: pectin contents within cultivar were calculated from a total of sixteen measurements); mean ± standard deviation values followed by the same letter within a column and condition (cultivar or method) are not significantly different (p ≦ 0.05).
²g/100 g raw potato tissue solids (based on the potato tissue used in the initial fractionation)
³RB = Russet Burbank; RN = Russet Norkotah
⁴ALK = Alkaline Isolation Method; ENZ = Enzyme Isolation Method
⁵n/a = not applicable

(TRS) in comparison to RN.

By contrasting the two fractionation methods (Table 2):

The ENZ (relative to the ALK) fractionation method generated on average a higher proportion of ‘Cell’ fraction material (corresponding to less remaining ‘Residue’), but did not recover any pectin (due to enzyme hydrolysis).

The ALK method generated a higher amount of ‘Starch’ and a higher recovery of solids (TRS), though the difference in TRS appeared to be attributable to the lack of pectin recovery by the ENZ method.

Isolated ‘Cell’ Fraction Microstructure

The microstructure of isolated ‘Cell’ fractions consisted primarily of intact parenchyma cells, which contained clusters of starch granules (visible through a semi-transparent cell wall structure). Starch granules within parenchyma cells retained their native birefringence (data not shown). In contrast, the cellular structures of commercial potato granules (obtained via heat processing) no longer exhibit visible native starch granules (as a result of starch gelatinization).

No microstructural differences were observed between the ‘Cell’ fractions of two cultivars (RB vs. RN) or fractionation methods (ENZ vs. ALK) by SEM (data not shown).

Composition of Isolated ‘Cell’ Fractions

Isolated parenchyma ‘Cell’ fractions exhibited reduced lipid, protein, and ash contents, and increased carbohydrate and starch contents, relative to the whole tissue control flours (Table 3). Losses of lipid, protein, and ash during fractionation had the effect of increasing or concentrating the carbohydrate and starch contents relative to those of the control whole-tissue potato flours.

Losses of non-starch polysaccharides (NSP) appeared to vary according to the fractionation scheme, with the ENZ method resulting in a greater loss of NSP than the ALK method (in comparison to those of control whole-tissue potato flours) (Table 3).

TABLE 3
Mean¹ proximate composition (g/100 g) of the isolated parenchyma ‘Cell’ fractions
representing the four cultivar-fractionation methods, and whole-tissue (control) potato flours

| Cultivar/ | | | | Total | | |
|---|---|---|---|---|---|---|
| Method | Lipid | Ash | Protein | Carbohydr.² | Starch | NSP³ |
| RB⁴/ALK⁵ | 0.04 ± 0.09 ^{b} | 0.59 ± 0.07 ^{b} | 1.50 ± 0.28 ^{e} | 97.87 ± 0.19 ^{a} | 83.76 ± 1.48 ^{ab} | 14.11 ± 1.52 ^{b} |
| RN⁴/ALK⁵ | 0.05 ± 0.07 ^{b} | 0.82 ± 0.10 ^{b} | 2.09 ± 0.21 ^{d} | 97.04 ± 0.35 ^{a} | 82.86 ± 1.73 ^{b} | 14.18 ± 1.47 ^{b} |
| RB⁴/ENZ⁵ | 0.06 ± 0.06 ^{b} | 0.40 ± 0.12 ^{b} | 2.27 ± 0.18 ^{d} | 97.28 ± 0.12 ^{a} | 85.63 ± 1.33 ^{a} | 11.65 ± 1.37 ^{c} |
| RN⁴/ENZ⁵ | 0.09 ± 0.07 ^{b} | 0.47 ± 0.04 ^{b} | 3.67 ± 0.45 ^{c} | 95.77 ± 0.37 ^{b} | 85.50 ± 1.80 ^{a} | 10.27 ± 1.57 ^{c} |
| RB⁴/Control⁵ | 0.18 ± 0.03 ^{a} | 3.78 ± 1.05 ^{a} | 11.70 ± 0.24 ^{b} | 84.34 ± 1.24 ^{c} | 68.49 ± 0.97 ^{c} | 15.85 ± 2.17 ^{b} |
| RN⁴/Control⁵ | 0.18 ± 0.03 ^{a} | 3.98 ± 0.10 ^{a} | 13.41 ± 0.15 ^{a} | 82.44 ± 0.12 ^{d} | 62.18 ± 3.65 ^{d} | 20.26 ± 3.59 ^{a} |

¹Means were calculated from a total of four measurements (exception: starch content was calculated from a total of eight measurements); mean ± standard deviation values followed by the same letter within a column are not significantly different (p ≦ 0.05).
²Carbohydrate was calculated by difference (carbohydrate = 100 − lipid − protein − ash)
³Non starch polysaccharides (NSP) were calculated by difference (NSP = carbohydrate − starch)
⁴RB = Russet Burbank; RN = Russet Norkotah
⁵ALK = Alkaline Isolation Method; ENZ = Enzyme Isolation Method; Control = lyophilized whole-tissue potato flour

Thermal Properties of Isolated ‘Cell’ Fractions

All isolated ‘Cell’ fractions possessed higher enthalpy values than their respective control whole-tissue potato flours (Table 4, blue box) (due to the relative higher concentration of starch within the ‘Cell’ fractions, refer to Table 3).

Values of To, Tp, and Tc for RB and RN ALK ‘Cell’ fractions were consistently 2-4° C. higher than those of their respective whole-tissue control flours (Table 4, gray box; may be due to the disruption of granule amorphous regions via alkaline treatment).

Both RB and RN ENZ ‘Cell’ fractions exhibited reduced gelatinization temperature ranges compared to both the ALK ‘Cell’ fractions and whole-tissue control potato flours (Table 4, red box). This phenomenon was attributable to a starch annealing effect that occurred during treatment of the raw potato tissue with pectinase enzyme (treatment temperature was 50° C.).

TABLE 4
Mean¹ thermal properties of ‘Cell’ fractions representing the four cultivar-
fractionation methods, and of whole-tissue reference control flours

| Cultivar/Method | Tₒ (° C.) | Tₚ (° C.) | T_{c} (° C.) | ΔH (J/g) | Range (° C.) |
|---|---|---|---|---|---|
| RB²/ALK³ | 59.37 ± 0.17 ^{f} | 63.84 ± 0.18 ^{d} | 74.35 ± 0.67 ^{d} | 13.73 ± 0.96 ^{a} | 14.98 ± 0.67 ^{a} |
| RN²/ALK³ | 64.30 ± 0.40 ^{c} | 69.41 ± 0.40 ^{b} | 80.26 ± 0.50 ^{b} | 12.72 ± 0.66 ^{a} | 15.96 ± 0.30 ^{a} |
| RB²/ENZ³ | 63.30 ± 0.56 ^{d} | 66.55 ± 0.84 ^{c} | 75.10 ± 1.19 ^{d} | 13.65 ± 1.38 ^{a} | 11.79 ± 0.75 ^{c} |
| RN²/ENZ³ | 66.03 ± 0.33 ^{b} | 70.03 ± 0.48 ^{b} | 79.88 ± 0.56 ^{b} | 13.16 ± 0.41 ^{a} | 13.86 ± 0.30 ^{b} |
| RB²/Control³ | 61.32 ± 0.18 ^{e} | 66.72 ± 0.12 ^{c} | 76.94 ± 0.97 ^{c} | 10.97 ± 0.96 ^{b} | 15.62 ± 1.05 ^{a} |
| RN²/Control³ | 67.97 ± 1.02 ^{a} | 73.56 ± 0.79 ^{a} | 83.27 ± 0.54 ^{a} | 10.84 ± 0.62 ^{b} | 15.30 ± 1.06 ^{a} |

¹Mean values were calculated from a total of four measurements; mean ± standard deviation and values followed by the same letter within a column are not significantly different (p ≦ 0.05).
²RB = Russet Burbank; RN = Russet Norkotah
³ALK = Alkaline Isolation Method; ENZ = Enzyme Isolation Method; Control = lyophilized whole-tissue potato flour

### Resistant Starch (RS) Characteristics of Select Isolated ‘Cell’ Fractions

In absence of heating, the majority of starch (˜77-89%) within isolated ‘Cell’ fractions was classified as RS, while most of the starch (˜94%) within commercial potato granules (previously heat-processed) was readily digestible (Table 5).

However, as expected, the RS content of ‘Cell’ fractions was reduced to near-zero levels upon cooking. Thus, further treatment will be necessary to stabilize the native starch granular structure and/or cell wall structure to promote additional resistance to starch subjected to heat treatment.

TABLE 5
Mean¹ RS characteristics of select ‘Cell’ fractions and
commercial potato granules before and after heat treatment.

| | | Without Heating | | After Heating⁴ | |
|---|---|---|---|---|---|
| Cultivar/Method | Total Starch | RDS/SDS⁵ | RS⁵ | RDS/SDS⁵ | RS⁵ |
| RB²/ENZ³ | 81.4 ± 0.5 | 18.2 ± 0.3 | 63.2 ± 0.7 | 67.8 ± 1.3 | 0.5 ± 0.1 |
| RN²/ENZ³ | 78.3 ± 0.7 | 8.1 ± 0.2 | 70.1 ± 0.6 | 63.7 ± 0.7 | 0.8 ± 0.2 |
| RN²/ALK³ | 77.7 ± 0.7 | 8.4 ± 0.1 | 69.2 ± 0.7 | 62.6 ± 0.7 | 0.5 ± 0.0 |
| Commercial Potato | 63.6 ± 1.2 | 60.1 ± 1.1 | 3.6 ± 0.4 | 55.9 ± 0.1 | 2.9 ± 0.1 |
| Granules | | | | | |

Both ENZ and ALK fractionation methods proved capable of isolating intact parenchyma cells with reasonable yield from raw potato tissue in the absence of heating, though the ENZ method was the more efficient of the two methods (53% yield from raw tissue).

Future work will be needed to investigate recovery of solubles (i.e., protein) lost during the fractionation process for add-back to the ‘Cell’ material.

The potato ‘Cell’ material could be potentially utilized ‘as is’ in low-moisture food applications (e.g., baked or snack products) where water content is low, thus limiting the extent of gelatinization.

Additional physical and/or chemical treatments will be necessary to modify physical properties and/or enhance the RS stability of the ‘Cell’ material for use in high temperature processes.

What is claimed is:

1. A method of preparing a heated food product comprising at least 5% w/w resistant starch, said method comprising heating an uncooked food comprising greater than 5% of its starch in the native or ungelatinized state at a temperature of between about 60° C. and 250° C., wherein the starch moisture content of the food product is between about 2% and about 35% w/w.

2. A method of preparing a heated food product comprising at least 5% w/w resistant starch, said method comprising heating an uncooked food product comprising greater than 5% w/w type 2 resistant starch at a temperature of between about 60° C. and 250° C., wherein the moisture content of the food product is between about 2% and about 35% w/w.

3. A potato-based food product ready for human consumption comprising greater than 5% of its starch in the native or ungelatinized state.

4. A cooked potato-based food product ready for human consumption comprising greater than 5% of its starch in the native or ungelatinized state.
